(19) United States
(12) Patent Application Publication
(10) Pub. No.: US 2004/0151759 A1
(43) Pub. Date: Aug. 5, 2004

(54) Non-animal product containing veterinary formulations

(76) Inventors: Douglas Cleverly, New Lynn Auckland (NZ); Michelle Hagenbuch, Greenbrook, NJ (US); Jun Chen, Robbinsville, NJ (US); Abul Azad, South Brunswick, NJ (US); James Muhitch, Monmouth Junction, NJ (US); Wen-Hsia Chen, Dayton, NJ (US); Hassan Nached, Branford, CT (US)

Correspondence Address: Judy JARECKI-BLACK, Ph.D., J.D., 3239 Satellite Blvd., Duluth, GA, 30096, US

(21) Appl. No.: 10/745,784

(22) Filed: Dec. 23, 2003

Related U.S. Application Data
(63) Continuation-in-part of application No. 10/222,559, filed on Aug. 16, 2002.

(51) Int. Cl. A23K 1/165

(52) U.S. Cl. 424/442; 119/710

(57) ABSTRACT

This invention provides for a chewable veterinary formulation, which does not contain animal products, which comprises:

effective amount of a pharmaceutically active agent which comprises either:

a) at least one nodulisporamide acid or nodulisporic acid derivative; or

b) a combination comprising

i) at least one avermectin or milbemycin derivative; and

ii) at least one compound selected from the group consisting of praziquantel and pyrantel;

at least one binder;

at least one disintegrant;

at least one non-animal product containing flavor or flavor derived from a non-animal source;

at least one binder;

at least one humectant;

at least one granulating solvent; and

optionally, at least one antioxidant, at least one buffering agent, at least one preservative, or at least one colorant.

### RELATED APPLICATIONS

This application is a continuation-in-part of copending application U.S. Ser. No. 10/222,559, filed Aug. 16, 2002, and herein incorporated by reference. Reference is also made to copending application Ser. No. 10/618,975, filed Jul. 14, 2003. These above-mentioned applications, as well as all documents cited therein, including parent applications, if available, and documents referred or cited herein, are hereby incorporated by reference.

### BACKGROUND OF THE INVENTION

1. Field of the Invention

This invention provides for improved oral veterinary formulations, which do not contain animal products or flavors derived from animal sources, which are palatable to the animal because of their good organoleptic properties, as well as a method to improve the palatability of oral veterinary formulations, without resorting to the use of animal products or flavors derived from animal products. This invention further provides for improved chewable veterinary formulations or tablets, which do not contain animal products or flavors derived from animal sources and possess good consistency and acceptability by the animal.

2. Description of the Related Art

Therapeutic agents are administered to animals by a variety of routes. These routes include, for example, oral ingestion, topical application or parental administration. The particular route selected by the practitioner depends upon factors such as the physiochemical properties of the pharmaceutical or therapeutic agent, the condition of the host, and economics.

For example, one method of formulating a therapeutic agent for oral, topical, dermal or subdermal administration is to formulate the therapeutic agent as a paste or as an injectable formulation and reference is made to U.S. application Ser. No. 09/504,741, filed Feb. 16, 2000, now pending, entitled IMPROVED PASTE FORMULATIONS or to Ser. No. 09/346,905, filed Jul. 2, 1999, now U.S. Pat. No. 6,239,112; Ser. No. 09/112,690, filed Jul. 9, 1999, now U.S. Pat. No. 5,958,888; and Ser. No. 09/152,775, filed Sep. 14, 1998, now U.S. Pat. No. 6,174,540, entitled LONG ACTING INJECTABLE FORMULATIONS CONTAINING HYDROGENATED CASTOR OIL. The disclosure of these patent applications as well as the references cited therein and the references cited herein are expressly incorporated by reference.

Other methods include placing the therapeutic agent in a solid or liquid matrix for oral delivery. These methods include chewable drug-delivery formulations. The problem associated with oral formulations is that the therapeutic agent often provides an unpleasant taste, aroma, or mouth feel to the formulation, which cause, especially in the situation with animals, the oral formulation to be rejected by the patient. See, e.g., U.S. Pat. No. 5,380,535 to Geyer et al., which provides for a lipid based, chewable formulations for oral delivery of therapeutic agents, such as aspirin, ibuprofen or erythromycin, which are unpalatable to humans; U.S. Pat. No. 5,894,029 to Brown et al., which provides for dried puff pet foods comprising farinaceious materials, proteinaceous materials, such as meats or vegetable protein sources, and optionally medicaments or vitamins; or U.S. Pat. No. 5,637,313 to Chau et al., which describes chewable dosage forms comprising a water soluble matrix comprising hydrogenated starch hydrolystate bulking agent and a water insoluble bulking agent.

Traditionally, in veterinary formulations, palatability had been achieved by the inclusion of animal byproducts or flavors derived from animal sources into the formulation. For example, it is customary to include attracts, such as chicken powder, liver powder, beef, ham, fish, or rawhide-derived products in dog chews to make the chew palatable to the dog. See, e.g., U.S. Pat. Nos. 6,086,940; 6,093,441; 6,159,516; 6,110,521; 5,827,565; 6,093,427, all to Axelrod et al. However, the use of animal products or byproducts or flavors derived from animal sources have recently fallen into disfavor because of the possibility of chemical or biological contamination, which lead to toxicity or diseases such as bovine spongiform encephalopathy. Hence, there is a need for oral veterinary formulations that do not contain animal products, byproducts, or flavors derived from animal sources while still exhibiting good organoleptic properties. While non-animal derived products such as valerian plants are know as scent attractants in food products or pet toys (U.S. Pat. No. 5,785,382 to Childers-Zadah) or animal chews that contain fruit flavors as the attractant (see, U.S. Pat. Nos. 6,274,182; 6,200,616 and 6,126,978 to Axelrod et al.), these patents do not describe using valerian plants or fruit flavors in oral formulations in which the pharmaceutical agents needs to be masked.

### DESCRIPTION OF THE INVENTION

The present invention provides for improved oral veterinary formulations comprising at least one nodulisporic acid or nodulisporic acid derivative, which do not contain animal products or flavors derived from animal sources, that exhibit organoleptic properties that the animal finds appealing. This invention further provides for improved chewable veterinary formulations or which do not contain animal products or flavors derived from animal sources and possess good consistency and acceptability by the animal, as well as an improved process to prepare chewable veterinary formulations.

In this disclosure and in appended claims, terms such as “comprising” and “comprises” and the like, have the meanings ascribed to them in U.S. Patent Case Law. The terms “comprises” and “comprising” are open-ended and allow for the inclusion of additional ingredients or steps.

Clearly, a chewable veterinary formulation, which does not contain animal products which comprises at least one nodulisporic acid or a derivative thereof, advantageously t-butyl nodulisporamide, is a basic or novel feature of the herein invention, as well as methods for preventing or treating parasites on an animal, e.g., dog, cat, by applying the formulation, e.g., monthly, and methods for preparing the formulations, e.g., by administering the ingredients, are also novel and basic features of the invention. That the invention performs as herein described is surprising, unexpected and nonobvious.

These and other embodiments are disclosed or are obvious, from and encompassed by, the following Detailed Description.

### DETAILED DESCRIPTION

The present invention provides for a chewable veterinary formulation, which does not contain animal products, which comprises:

effective amount of a pharmaceutically active agent which comprises either:

a) at least one nodulisporamide acid or nodulisporic acid derivative; or

b) a combination comprising

i) at least one avermectin or milbemycin derivative; and

ii) at least one compound selected from the group consisting of praziquantel and pyrantel;

at least one filler;

at least one disintegrant;

at least one non-animal product containing flavor or flavor derived from a non-animal source;

at least one binder;

at least one humectant;

at least one granulating solvent, for example, water or an aqueous sorbitol solution; and

optionally, at least one antioxidant, at least one buffering agent, at least one preservative, or at least one colorant; and optionally, a coating; or, preferably, a chewable veterinary formulation, which does not contain animal products, which comprises:

effective amount of a pharmaceutically active agent which comprises either:

a) at least one nodulisporamide acid or nodulisporic acid derivative; or

b) a combination comprising

i) at least one avermectin or milbemycin derivative; and

ii) at least one compound selected from the group consisting of praziquantel and pyrantel;

a filler selected from the group consisting of soy protein, corn cob, or corn glutton meal;

disintegrant;

a non-animal product containing flavor or a flavor derived from non-animal source which is a hickory smoke flavor;

a binder;

humectant;

granulating solvent;

optionally, an antioxidant, a buffering agent, preservative, or a colorant; and

is optionally coated at least one coating.

Further, the present invention provides for a method for enhancing the palatability of an oral veterinary formulation comprising at least one nodulisporic acid or nodulisporic acid derivative, which does not contain animal products or flavors derived from animal sources which comprises adding a hickory smoke flavor, which optionally further comprises caramel, to the oral veterinary formulation.

Most preferred are chewable veterinary formulations, which do not contain animal products, which comprise:

an effective amount of a pharmaceutically active agent which comprises either

a) at least one nodulisporamide acid or nodulisporic acid derivative; or

b) a combination comprising:

i) at least one avermectin or milbemycin derivative; and

ii) at least one compound selected from the group consisting of praziquantel and pyrantel;

about 20 to about 60% of a filler selected from the group consisting of soy protein, corn cob, or corn glutton meal;

about 1 to about 20% of a disintegrant;

about 0.1 to about 20% of a non-animal product containing flavor; or a flavor derived from a non-animal source;

about 0.5 to 10% a binder;

about 5 to about 20% of a humectant; and

about 5 to about 20% granulating solvent, based upon total weight of formulation. Especially preferred are chewable veterinary formulations, which do not contain animal products which comprise:

an effective amount of a pharmaceutically active agent which comprises either:

a) at least one nodulisporamide acid or nodulisporic acid derivative; or

b) a combination comprising:

i) at least one avermectin or milbemycin derivative; and

ii) at least one compound selected from the group consisting of praziquantel and pyrantel:

about 20 to about 60% of a filler selected from the group consisting of soy protein, corn cob, or corn glutton meal;

about 1 to about 20% of a disintegrant;

about 0.1 to about 20% of the non-animal product containing flavor or flavor derived from a non-animal source is a hickory barbecue flavor;

about 0.5 to 10% a binder;

about 5 to about 20% of a humectant; and

about 5 to about 20% granulating solvent, and, optionally

about 0.05% to about 1.0% of an antioxidant,

about 0.05 to about 1.0% of a preservative, and

about 0.001 to about 10% of a colorant, based upon total weight of formulation. The formulations wherein the nodulisporic acid derivative is t-butyl nodulisporamide (or “nodulisporamide”) are especially preferred.

Another preferred embodiment is a tablet, which does not contain animal products, which comprises:

an effective amount of a pharmaceutically active agent which comprises either:

a) at least one nodulisporamide acid or nodulisporic acid derivative; or

b) a combination comprising:

i) at least one avermectin or milbemycin derivative; and

ii) at least one compound selected from the group consisting of praziquantel and pyrantel;

at least one filler;

at least one non-animal product containing flavor or flavor derived from a non-animal source;

at least one lubricant;

at least one flow aid; and

optionally, at least one antioxidant, at least one pH modifier, at least one binder, at least one disintegrant, at least one surfactant, at least one preservative, and at least one colorant, and is optionally coated with at least one coating.

Also provided for by the present invention are chewable veterinary formulations comprising at least two pharmaceutically active agents wherein at least one of the agents is nodulisporic acid or a nodulisporic acid derivative. The additional pharmaceutically active agents in this embodiment may include nodulisporic acid or an additional nodulisporic acid derivative or a further pharmaceutically active compound.

Classes of further pharmaceutical agents that may be included in the inventive formulations include insecticides, acaricides, parasiticides, growth enhancers, oil-soluble, nonsteroidal anti-inflammatory drugs (NSAIDS), proton pump inhibitors and antibacterial compounds. Specific classes of compounds which fall within these classes include, for example, avermectins (such as ivermectin, abamectin, emamectin, eprinomectin, doramectin, moxidectin and selamectin), milbemycins, estrogens, progestins, androgens, substituted pyridylmethyl derivatives, phenylpyrazoles, COX-2 inhibitors, 2-(2-benzimidazolyl)-pyrimidines derivatives, macrolide antibiotics 2-acyl-4-oxo-pyrazino-isoquinoline derivatives, such as praziquantel or 1,4.5,6-tetrahydro-2-[2-substituted]vinyl pyrimidines and 2-[(2-substituted)vinyl]-2-imidazolines such as pyrantel (see U.S. Pat. No. 3,502,661, herein incorporated by reference.)

Nodulisporic acid and nodulisporic acid derivatives are known in the art as potent endo- and ectoantiparasitic agents. These compounds are based upon three structures, A, B or C, which have the following structures:

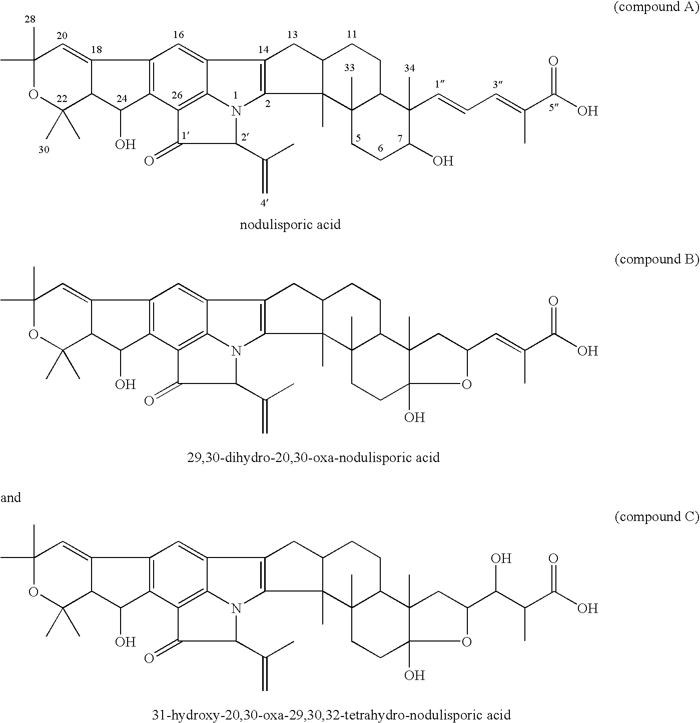

These compounds were obtained from the fermentation culture of Nodulisporium sp. MF-5954 (ATCC 74245) and the isolation and purification of the three nodulisporic acids are disclosed in U.S. Pat. No. 5,399,582. Derivatives of these compounds are described in WO 96/29073 and U.S. Pat. Nos. 5,945,317; 5,962,499; 5,834,260; 6,399,796; 6,221,894; 6,136,838; 5,595,991; 5,299,582; and 5,614,546.

Nodulisporic acid derivatives possess potent activity against parasites, particularly helminths, ectoparasites, insects, and acaricides, infecting man, animals and plants. These compounds have utility in human and animal health, agriculture and pest control in household and commercial areas.

The disease or group of diseases described generally as helminthiasis is due to infection of an animal host with parasitic worms known as helminths. Helminthiasis is a prevalent and serious economic problem in domesticated animals such as swine, sheep, horses, cattle, goats, dogs, cats, fish, buffalo, camels, llamas, reindeer, laboratory animals, forbearing animals, zoo animals and exotic species and poultry. Among the helminths, the group of worms described as nematodes causes widespread and often times serious infection in various species of animals. The most common genera of nematodes infecting the animals referred to above are Haemonchus, Trichostrongylus, Ostertagia, Nematodirus, Cooperia, Ascaris, Bunostomum, Oesophagostomum, Chabertia, Trichuris, Strongylus, Trichonema, Dictyocaulus, Capillaria, Habronema, Druschia, Heterakis, Toxocara, Ascaridia, Oxyuris, Ancylostoma, Uncinaria, Toxascaris and Parascaris. Certain of these, such as Nematodirus, Cooperia, and Oesophagostomum attack primarily the intestinal tract while others, such as Haemonchus and Ostertagia, are more prevalent in the stomach while still others such as Dictyocaulus are found in the lungs. Still other parasites may be located in other tissues and organs of the body such as the heart and blood vessels, subcutaneous and lymphatic tissue and the like. The parasitic infections The parasitic infections known as helminthiases lead to anemia, malnutrition, weakness, weight loss, severe damage to the walls of the intestinal tract and other tissues and organs and, if left untreated, may result in death of the infected host. The compounds of this invention have activity against these parasites, and in addition are also active against Dirofilaria in dogs and cats, Nematospiroides, Syphacia, Aspiculuris in rodents, arthropod ectoparasites of animals and birds such as ticks, mites such as scabies lice, fleas, blowflies, and other biting insects in domesticated animals and poultry, such as Ctenophalides, Ixodes, Psoroptes, and Hematobia, in sheep Lucilia sp., biting insects and such migrating dipterous larvae as Hypoderma sp. in cattle, Gasterophilus in horses, and Cuterebra sp. in rodents and nuisance flies including blood feeding flies and filth flies.

Nodulisporic acid derivatives are also useful against parasites which infect mammals, such as cats, dogs and humans. The most common genera of parasites of the gastrointestinal tract of man are Ancylostoma, Necator, Ascaris, Strongyloides, Trichinella, Capillaria, Trichuris, and Enterobius. Other medically important genera of parasites which are found in the blood or other tissues and organs outside the gastrointestinal tract are the filiarial worms such as Wuchereria, Brugia, Onchocerca and Loa, Dracunculus and extra intestinal stages of the intestinal worms Strongyloides and Trichinella. The compounds are also of value against arthropods parasitizing man, biting insects and other dipterous pests causing annoyance to man.

Nodulisporic acid derivatives are also active against household pests such as the cockroach, Blatella sp., clothes moth, Tineola sp., carpet beetle, Attagenus sp., the housefly Musca domestica as well as fleas, house dust mites, termites and ants.

Nodulisporic acid derivatives are also useful against insect pests of stored grains such as Tribolium sp., Tenebrio sp. and of agricultural plants such as aphids, (Acyrthiosiphon sp.); against migratory orthopterans such as locusts and immature stages of insects living on plant tissue. The compounds are useful as a nematocide for the control of soil nematodes and plant parasites such as Meloidogyne sp., which may be of importance in agriculture. The compounds are also highly useful in treating acreage infested with fire and nests. The compounds are scattered above the infested area in low levels in bait formulations which are brought back to the nest. In addition to a direct-but-slow onset toxic effect on the fire ants, the compound has a long-term effect on the nest by sterilizing the queen which effectively destroys the nest.

Nodulisporic acid and its derivatives are also effective against arthropod pests, for example fleas, ticks, ice and other biting insects in domesticated animals and poultry, such as Ctenocephalides, Ixodes, Psoroptes, Lucilia and Hematobia.

It is possible to combine nodulisporic acid or nodulisporic acid derivatives with other insecticides, parasiticides and acaricides in order to achieve a broader spectrum of activity or, in some instances synergy. For example, U.S. Pat. No. 5,945,317 discloses co-administering nodulisporic acid derivatives with avermectin, ivermectin, emamectin, eprinomectin, abamectin or milbemycins, or other antihelmintic agents, such as morantel, pyrantel, or febantel, praziquantel or benzimidizoles, such as thiabendazole or cambendazole. Other agents described therein include IGR compounds, such as lufenuron, methoprene or 1-N-arylpyrazoles, such a fipronil. See also, U.S. Pat. Nos. 5,962,499 and 6,221,894. While it is known in the art that it is sometimes possible to combine various parasiticides in order to broaden the antiparasitical spectrum, it is not possible to predict, a priori, which combinations will work for a particular animal or disease state. For this reason, the results of various combinations is not always successful and there is a need in the art for more effective formulations which may be easily administered to the animal.

This invention includes all nodulisporic acid derivatives know in the art, including all steroisomers, such as those described in the prior publication described above, which are expressly incorporated by reference. Especially preferred are formulations comprising nodulisporic acid derivatives of the formula:

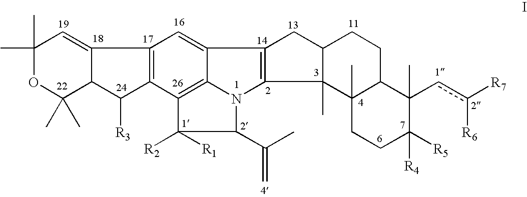

wherein

R₁ is

(1) hydrogen,

(2) optionally substituted alkyl,

(3) optionally substituted alkenyl,

(4) optionally substituted alkynyl,

(5) optionally substituted cycloalkyl,

(6) optionally substituted cycloalkenyl, where the substituents on the alkyl, alkenyl, alkynyl, cycloalkyl and cycloalkenyl are 1 to 3 groups independently selected from

(i) alkyl,

(ii) X-alkyl, where X is O or S(O)ₘ.

(iii) cycloalkyl,

(iv) hydroxy,

(v) halogen,

(vi) cyano,

(vii) carboxy,

(viii) NY¹Y², where Y¹ and Y² are independently H or alkyl,

(ix) alkanoylamino, and

(x) aroylamino wherein said aroyl is optionally substituted with 1 to 3 groups independently selected from R^{f}

(7) aryl or arylalkyl, wherein said aryl is optionally substituted with 1 to 3 groups independently selected from R^{f},

(8) perfluoroalkyl

(9) a 5- or 6-member heterocycle containing from 1 to 4 heteroatoms independently selected from oxygen, sulfur and nitrogen atoms optionally substituted by 1 to 3 groups independently selected from hydroxy, oxo, alkyl and halogen, and which may be saturated or partly unsaturated,

R₂, R₃, and R₄ are independently OR^{a}, OCO₂R^{b}, OC(O)NR^{c}R^{d}; or

R₁ and R₂ represent ═O, ═NOR^{a} or ═N—NR^{c}R^{d};

R₅ and R₆ are H; or

R₅ and R₆ together represent —O—;

R₇ is

(1) CHO, or

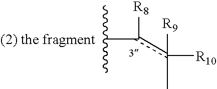

R₈ is

(1) H,

(2) OR^{a}, or

(3) NR^{c}R^{d}

R₉ is

(1) H, or

(2) OR^{a};

R₁₀ is

(1) CN,

(2) C(O)OR^{b},

(3) C(O)N(OR^{b})R^{c},

(4) C(O)NR^{c}R^{d},

(5) NHC(O)OR^{b},

(6) NHC(O)NRCR^{d},

(7) CH₂OR^{a},

(8) CH₂OCO₂R^{b},

(9) CH₂OC(O)NR^{c}R^{d},

(10) C(O)NR^{c}NR^{c}R^{d}, or

(11) C(O)NR^{c}SO₂R^{b};

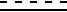

represents a single or a double bond;

R^{a} is

(1) hydrogen,

(2) optionally substituted alkyl,

(3) optionally substituted alkenyl,

(4) optionally substituted alkynyl,

(5) optionally substituted alkanoyl,

(6) optionally substituted alkenoyl,

(7) optionally substituted alkynoyl,

(8) optionally substituted aroyl,

(9) optionally substituted aryl,

(10) optionally substituted cycloalkanoyl,

(11) optionally substituted cycloalkenoyl,

(12) optionally substituted alkylsulfonyl

(13) optionally substituted cycloalkyl

(14) optionally substituted cycloalkenyl where the substituents on the alkyl, alkenyl, alkynyl, alkanoyl, alkenoyl, alkynoyl, aroyl, aryl, cycloalkanoyl, cycloalkenoyl, alkylsulfonyl, cycloalkyl and cycloalkenyl are from 1 to 10 groups independently selected from hydroxy, alkoxy, cycloalkyl, arylalkoxy, NR^{g}R^{h}, CO₂R_{b}, CONR^{c}R^{d} and halogen,

(15) perfluoroalkyl,

(16) arylsulfonyl optionally substituted with 1 to 3 groups independently selected from alkyl, perfluoroalkyl, nitro, halogen and cyano,

(17) a 5- or 6-member heterocycle containing 1 to 4 heteroatoms selected from oxygen, sulfur and nitrogen optionally substituted by 1 to 4 groups independently selected from alkyl, alkenyl, perfluoroalkyl, amino, C(O)NR^{c}R^{d}, cyano, CO₂R^{b} and halogen, and which may be saturated or partly unsaturated;

R^{b} is

(1) H,

(2) optionally substituted aryl,

(3) optionally substituted alkyl,

(4) optionally substituted alkenyl,

(5) optionally substituted alkynyl,

(6) optionally substituted cycloalkyl,

(7) optionally substituted cycloalkenyl, or

(8) optionally substituted heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups independently selected from

(i) hydroxy,

(ii) alkyl,

(iii) oxo,

(iv) SO₂NR^{g}R^{h},

(v) arylalkoxy,

(vi) hydroxyalkyl,

(vii) alkoxy,

(viii) hydroxyalkoxy,

(ix) aminoalkoxy,

(x) cyano,

(xi) mercapto,

(xii) alkyl-S(O)ₘ,

(xiii) cycloalkyl optionally substituted with 1 to 4 groups independently selected from R^{e},

(xiv) cycloalkenyl,

(xv) halogen,

(xvi) alkanoyloxy,

(xvii) C(O)NR^{g}R^{h},

(xviii) CO₂Rⁱ,

(xix) formyl,

(xx) —NR^{g}R^{h},

(xxi) 5- to 9-member heterocycle, which may be saturated or partially unsaturated, containing from 1 to 4 heteroatoms independently selected from oxygen, sulfur and nitrogen, and optionally substituted with 1 to 5 groups independently selected from R^{e},

(xxii) optionally substituted aryl, wherein the aryl substituents are 1,2-methylenedioxy or 1 to 5 groups independently selected from R^{e},

(xxiii) optionally substituted arylalkoxy, wherein the aryl substituents are 1,2-methylenedioxy or 1 to 5 groups independently selected from R^{e}, and

(xxiv) perfluoroalkyl;

R^{c} and R^{d} are independently selected from R^{b}; or

R^{c} and R^{d} together with the N to which they are attached form a 3- to 10-member ring containing 0 to 2 additional heteroatoms selected from 0, S(O)ₘ, and N, optionally substituted with 1 to 3 groups independently selected from R^{g}, hydroxy, thioxo and oxo;

R^{e} is

(1) halogen,

(2) alkyl,

(3) perfluoroalkyl,

(4) —S(O)ₘRⁱ,

(5) cyano,

(6) nitro,

(7) R₁₀(CH₂)v-,

(8) RⁱCO₂(CH₂)v-,

(9) RⁱOCO(CH₂)v-,

(10) optionally substituted aryl where the substituents are from 1 to 3 of halogen, alkyl, alkoxy, or hydroxy,

(11) SO₂NR^{g}R^{h}, or

(12) amino;

R^{f} is

(1) alkyl,

(2) X—C₁-C₄ alkyl, where X is O or S(O)ₘ,

(3) alkenyl,

(4) alkynyl,

(5) perfluoroalkyl,

(6) NY¹Y², where Y¹ and Y² are independently H or alkyl,

(7) hydroxy,

(8) halogen, and

(9) alkanoylarnino,

R^{g} and R^{h} are independently

(1) hydrogen,

(2) alkyl optionally substituted with hydroxy, amino, or CO₂Rⁱ

(3) aryl optionally substituted with halogen, 1,2-methylenedioxy, alkoxy, alkyl or perfluoroalkyl,

(4) arylalkyl, wherein the aryl is optionally substituted with perfluorolkyl or 1,2-methylenedioxy;

(5) alkoxycarbonyl,

(6) alkanoyl,

(7) alkanoylalkyl,

(9) aryl alkoxycarbonyl,

(10) aminocarbonyl,

(11) monoalkylaminocarbonyl

(12) dialkylaminocarbonyl; or

R^{g} and R^{h} together with the N to which they are attached form a 3- to 7-member ring containing 0 to 2 additional heteroatoms selected from O, S(O)ₘ, and N, optionally substituted with 1 to 3 groups independently selected from R^{e} and oxo;

Rⁱ is

(1) hydrogen,

(2) perfluoroalkyl,

(3) alkyl,

(4) optionally substituted aryl or arylalkyl, where the aryl substituents are from 1 to 3 groups independently selected from halogen, alkyl, alkoxy, and hydroxy;

m is 0 to 2; and

v is 0 to 3; or a pharmaceutically acceptable salt thereof.

In a preferred embodiment, the present invention provides compounds of Formula I wherein

R₁ is

(1) hydrogen,

(2) optionally substituted alkyl,

(3) optionally substituted alkenyl,

(4) optionally substituted alkynyl,

(5) optionally substituted cycloalkyl,

(6) optionally substituted cycloalkenyl where the substituents on the alkyl, alkenyl, alkynyl, cycloalkyl and cycloalkenyl are 1 to 3 groups independently selected from

(i) alkyl,

(ii) X—C₁-C₆ alkyl, where X is O or S(O)ₘ,

(iii) cycloalkyl,

(iv) hydroxy,

(v) halogen,

(vi) cyano,

(vii) carboxy, and

(viii) NY¹Y², where Y¹ and Y² are independently H or alkyl,

(7) aryl or arylalkyl wherein said aryl is optionally substituted with 1 to 3 groups independently selected from R^{f},

(8) perfluoroalkyl,

(9) a 5- or 6-member heterocycle containing from 1 to 4 heteroatoms independently selected from oxygen, sulfur and nitrogen atoms optionally substituted by 1 to 3 groups independently selected from hydroxy, oxo, alkyl and halogen, and which may be saturated or partly unsaturated,

R₈is

(1) H,

(2) OH, or

(3) NH₂;

R₉ is

(1) H or

(2) OH;

R₁₀ is

(1) C(O)OR^{b},

(2) C(O)N(OR^{b})R^{c},

(3) C(O)NR^{c}R^{d},

(4) NHC(O)OR^{b},

(5) NHC(O)NR^{c}R^{d},

(6) CH₂OR^{a},

(7) CH₂OCO₂R^{b},

(8) CH₂OC(O)NR^{c}R^{d},

(9) C(O)NR^{c}NR^{c}R^{d}, or

(10) C(O)NR^{c}SO₂R^{b};

R^{a} is

(1) hydrogen,

(2) optionally alkyl,

(3) optionally substituted alkenyl,

(4) optionally substituted alkynyl,

(5) optionally substituted alkanoyl,

(6) optionally substituted alkenoyl,

(7) optionally substituted alkynoyl,

(8) optionally substituted aroyl,

(9) optionally substituted aryl,

(10) optionally substituted cycloalkanoyl,

(11) optionally substituted cycloalkenoyl,

(12) optionally substituted alkylsulfonyl

(13) optionally substituted cycloalkyl

(14) optionally substituted cycloalkenyl where the substituents on the alkyl, alkenyl, alkynyl, alkanoyl, alkenoyl, alkynoyl, aroyl, aryl, cycloalkanoyl, cycloalkenoyl, alkylsulfonyl, cycloalkyl and cycloalkenyl are from 1 to 10 groups independently selected from hydroxy, alkoxy, cycloalkyl, aryl alkoxy, NR^{g}R^{h}, CO₂R^{b}, CONR^{c}R^{d} and halogen,

(15) perfluoroalkyl,

(16) arylsulfonyl optionally substituted with 1 to 3 groups independently selected from alkyl, perfluoroalkyl, halogen and cyano,

(17) a 5- or 6-member heterocycle containing 1 to 4 heteroatoms selected from oxygen, sulfur and nitrogen optionally substituted by 1 to 4 groups independently selected from alkyl, alkenyl, perfluoroalkyl, amino, C(O)NR^{c}R^{d}, cyano, CO₂R^{b} and halogen, and which may be saturated or partly unsaturated;

R^{b} is

(1) H,

(2) optionally substituted aryl,

(3) optionally substituted alkyl,

(4) optionally substituted alkenyl,

(5) optionally substituted alkynyl,

(6) optionally substituted cycloalkyl,

(7) optionally substituted cycloalkenyl, or

(8) optionally substituted 5- to 10-member heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups independently selected from

(i) hydroxy,

(ii) C₁-C₃ alkyl,

(iii) oxo,

(iv) SO₂NR^{g}R^{h},

(v) aryl alkoxy,

(vi) hydroxy alkyl,

(vii) alkoxy,

(viii) hydroxyalkoxy,

(ix) aminoalkoxy,

(x) cyano,

(xi) perfluoroalkyl,

(xii) alkyl-S(O)ₘ,

(xiii) cycloalkyl optionally substituted with 1 to 4 groups independently selected from R^{e},

(xiv) cycloalkenyl,

(xv) halogen,

(xvi) alkanoyloxy,

(xvii) C(O)NR^{g}R^{h},

(xviii) CO₂Rⁱ,

(xix) optionally substituted arylalkoxy, wherein the aryl substituents are 1,2-methylenedioxy or 1 to 5 groups independently selected from R^{e},

(xx) —NR^{g}R^{h},

(xxi) 5- to 6-member heterocycle, which may be saturated or partially unsaturated, containing from 1 to 4 heteroatoms independently selected from oxygen, sulfur and nitrogen, and optionally substituted with 1 to 5 groups independently selected from R^{e}, and

(xxii) optionally substituted aryl, wherein the aryl substituents are 1,2-methylenedioxy or 1 to 5 groups independently selected from R^{e};

R^{e} is

(1) halogen,

(2) alkyl,

(3) perfluoroalkyl,

(4) —S(O)ₘRⁱ,

(5) cyano,

(6) amino,

(7) RⁱO(CH₂)ᵥ-,

(8) RⁱCO₂(CH₂)ᵥ-,

(9) RⁱOCO(CH₂)ᵥ-,

(10) optionally substituted aryl where the substituents are from 1 to 3 of halogen, alkyl, alkoxy, or hydroxy, or

(11) SO₂NR^{g}R^{h};

R^{f} is

(1) methyl,

(2) X—C₁-C₂ alkyl, where X is O or S(O)ₘ,

(3) halogen,

(4) acetylamino,

(5) trifluoromethyl,

(6) NY¹Y², where Y¹ and Y² are independently H or methyl, and

(7) hydroxy;

R^{g} and R^{h} are independently

(1) hydrogen,

(2) alkyl optionally substituted with hydroxy, amino, or CO₂Rⁱ

(3) aryl optionally substituted with halogen, 1,2-methylenedioxy, alkoxy, alkyl or perfluoroalkyl,

(4) arylalkyl, wherein the aryl is optionally substituted with perfluorolkyl or 1,2-methylenedioxy;

(5) alkoxycarbonyl,

(6) alkanoyl,

(7) alkanoyl alkyl,

(9) arylalkoxycarbonyl,

(10) aminocarbonyl,

(11) monoalkylaminocarbonyl

(12) dialkylarninocarbonyl; or

R^{g} and R^{h} together with the N to which they are attached form a 5- to 6-member ring containing 0 to 2 additional heteroatoms selected from O, S(O)ₘ, and N, optionally substituted with 1 to 3 groups independently selected from R^{e} and oxo;

Rⁱ is

(1) hydrogen,

(2) perfluoroalkyl,

(3) alkyl,

(4) optionally substituted arylalkyl, where the aryl substituents are from 1 to 3 groups independently selected from halogen, alkyl, alkoxy, and hydroxy; all other variables are as defined under Formula I.

In another preferred embodiment, the present invention provides compounds of Formula I wherein

R¹ is

(1) hydrogen,

(2) optionally substituted alkyl,

(3) optionally substituted alkenyl,

(4) optionally substituted alkynyl, where the substituents on the alkyl, alkenyl, and alkynyl are 1 to 3 groups independently selected from

(i) methyl,

(ii) X-methyl, where X is O or S(O)ₘ and

(iii) halogen,

(5) aryl or arylalkyl wherein said aryl is optionally substituted with 1 to 3 groups independently selected from R^{f}.

(6) trifluoromethyl

R_{g} is

(1) H,

(2) OH, or

(3) NH₂

R₉ is

(1) H, or

(2) OH;

R₁₀ is

(1) C(O)OR^{b},

(2) C(O)N(OR^{b})R^{c},

(3) C(O)NR^{c}R^{d},

(4) NHC(O)OR^{b},

(5) NHC(O)NR^{c}R^{d},

(6) CH₂OR^{a},

(7) CH₂OCO₂R^{b},

(8) CH₂OC(O)NR^{c}R^{d},

(9) C(O)NR^{c}NR^{c}R^{d}, or

(10) C(O)NR^{c}SO₂R^{b};

R^{a} is

(1) hydrogen,

(2) optionally substituted alkyl,

(3) optionally substituted alkenyl,

(4) optionally substituted alkynyl,

(5) optionally substituted alkanoyl,

(6) optionally substituted aroyl,

(7) optionally substituted cycloalkanoyl,

(8) optionally substituted cycloalkenoyl,

(9) optionally substituted alkylsulfonyl where the substituents on the alkyl, alkenyl, alkynyl, alkanoyl, aroyl, cycloalkanoyl, cycloalkenoyl, and alkylsulfonyl, are from 1 to 5 groups independently selected from hydroxy, alkoxy, aryl alkoxy, NR^{g}R^{h}, CO₂R^{b}, CONR^{c}R^{d} and halogen,

(10) trifluoromethyl,

(11) arylsulfonyl optionally substituted with 1 to 3 groups independently selected from methyl, trifluoromethyl and halogen,

(12) a 5- or 6-member heterocycle containing 1 to 4 heteroatoms selected from oxygen, sulfur and nitrogen optionally substituted by 1 to 4 groups independently selected from methyl, trifluoromethyl, C(O)NR^{c}R^{d}, CO₂R^{b} and halogen, and which may be saturated or partly unsaturated;

R_{b} is

(1) H,

(2) optionally substituted aryl,

(3) optionally substituted alkyl,

(4) optionally substituted alkenyl,

(5) optionally substituted alkynyl,

(6) optionally substituted cycloalkyl,

(7) optionally substituted cycloalkenyl, or

(8) optionally substituted 5- to 6-member heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups independently selected from

(i) hydroxy,

(ii) alkyl,

(iii) oxo,

(iv) SO₂NR^{g}R^{h},

(v) arylalkoxy,

(vi) hydroxyalkyl,

(vii) alkoxy,

(viii) hydroxy alkoxy,

(ix) amino alkoxy,

(x) cyano,

(xi) alkyl-S(O)ₘ,

(xii) cycloalkyl optionally substituted with 1 to 4 groups independently selected from R^{e},

(xiii) cycloalkenyl,

(xiv) halogen,

(xv) alkanoyloxy,

(xvi) C(O)NR^{g}R^{h},

(xvii) CO₂Rⁱ,

(xvii) —NR^{g}R^{h},

(xix) 5 to 6-member heterocycle, which may be saturated or partially unsaturated, containing from 1 to 4 heteroatoms independently selected from oxygen, sulfur and nitrogen, and optionally substituted with 1 to 5 groups independently selected from R^{e},

(xx) optionally substituted aryl, wherein the aryl substituents are 1,2-methylenedioxy or 1 to 5 groups independently selected from R^{e},

(xxi) optionally substituted aryl alkoxy, wherein the aryl substituents are 1,2-methylenedioxy or 1 to 5 groups independently selected from R^{e}, and

(xxii) perfluoroalkyl;

R^{e} is

(1) halogen,

(2) alkyl,

(3) perfluoroalkyl,

(4) —S(O)ₘRⁱ,

(5) cyano,

(6) RⁱO(CH₂)ᵥ-,

(7) RⁱCO₂(CH₂)ᵥ -,

(8) R₁₀CO(CH₂)ᵥ-,

(9) optionally substituted aryl where the substituents are from 1 to 3 of halogen, alkyl, alkoxy, or hydroxy,

(10) SO₂NR^{g}R^{h}, or (11) amino;

R^{f} is

(1) methyl,

(2) X—C₁-C₂ alkyl, where X is O or S(O)ₘ,

(3) trifluoromethyl,

(4) NY¹Y², where Y¹ and Y² are independently H or methyl,

(5) hydroxy,

(6) halogen, and

(7) acetylamino,

R^{g} and R^{h} are independently

(1) hydrogen,

(2) alkyl optionally substituted with hydroxy, amino, or CO₂Rⁱ

(3) aryl optionally substituted with halogen, 1,2-methylenedioxy, alkoxy, alkyl or perfluoroalkyl,

(4) arylalkyl, wherein the aryl is optionally substituted with perfluorolkyl or 1,2-methylenedioxy;

(5) alkoxycarbonyl,

(6) alkanoyl,

(7) alkanoylalkyl,

(9) arylalkoxycarbonyl,

(10) aminocarbonyl,

(11) monoalkylaminocarbonyl

(12) dialkylaminocarbonyl; or

R^{g} and R^{h} together with the N to which they are attached form a 5- to 6-membered ring containing 0 to 2 additional heteroatoms selected from O, S(O)ₘ, and N, optionally substituted with 1 to 3 groups independently selected from R^{e} and oxo;

Rⁱ is

(1) hydrogen,

(2) perfluoroalkyl,

(3) alkyl,

(4) optionally substituted aryl or arylalkyl, where the aryl substituents are from 1 to 3 groups independently selected from halogen, alkyl, alkoxy, and hydroxy; and all other variables are as defined under Formula I.

Most especially preferred are chewable veterinary formulations, wherein the composition comprises nodulisporic acid derivatives which are nodulisporamides, which are compounds of the formula

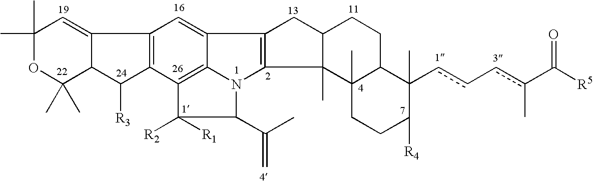

R₁ is

(1) hydrogen,

(2) optionally substituted C₁-C₁₀ alkyl,

(3) optionally substituted C₂-C₁₀ alkenyl,

(4) optionally substituted C₂-C₁₀ alkynyl,

(5) optionally substituted C₃-C₈ cycloalkyl,

(6) optionally substituted C₅-C₈ cycloalkenyl where the substituents on the alkyl, alkenyl, alkynyl, cycloalkyl and cycloalkenyl are 1 to 3 groups independently selected from C₁-C₅ alkyl, C₁-C₁₀ alkoxy, C₁-C₁₀ alkylthio, C₁-C₁₀ alkylsulfonyl, C₃-C8 cycloalkyl, hydroxy, halogen, cyano, carboxy, amino, C₁-C₁₀ monoalkylamino, C₁-C₁₀ dialkylamino, C₁-C₁₀ alkanoyl amino and benzoyl amino wherein said benzoyl is optionally substituted with 1 to 3 groups independently selected from C₁-C₄ alkyl, C₁-C₄ alkoxy, C₁-C₄ alkylthio, C₂-C₄ alkenyl, C₂-C₄ alkynyl, C₁-C₃- perfluoroalkyl, amino, hydroxy, halogen, C₁-C₅ monoalkylamino, C₁-C₅ dialkylamino and C₁-C₅ alkanoyl amino,

(7) phenyl C₀-C₅ alkyl wherein said phenyl is optionally substituted with 1 to 3 groups independently selected from C₁-C₄ alkyl, C₁-C₄ alkoxy, C₁-C₄ alkylthio, C₂-C₄ alkenyl, C₂-C₄ alkynyl, C₁-C₃ perfluoroalkyl, amino, hydroxy, carboxy, halogen, C₁-C₅ monoalkylamino, C₁-C₅ dialkylamino and C₁-C₅ alkanoyl amino,

(8) C₁-C₅ perfluoroalkyl,

(9) a 5- or 6-member ring selected from morpholino, pyridyl and piperazino, optionally substituted by 1 to 3 groups independently selected from hydroxy, oxo, C₁-C₁₀ alkyl and halogen,

R², R³, and R⁴ are independently OR^{a}, OCO₂R^{b}, OC(O)NR^{c}R^{d}; or R¹ and R² together represent ═O, ═NOR^{a} or ═N—NR^{c}R^{d};

R⁵ is NR^{c}R^{d},

R^{a} is

(1) hydrogen,

(2) optionally substituted C₁-C₁₀ alkyl,

(3) optionally substituted C₃-C₁₀ alkenyl,

(4) optionally substituted C₃-C₁₀ alkynyl,

(5) optionally substituted C₁-C₁₀ alkanoyl,

(6) optionally substituted C₁-C₁₀ alkenoyl,

(7) optionally substituted C₁-C₁₀ alkynoyl,

(8) optionally substituted benzoyl,

(9) optionally substituted phenyl,

(10) optionally substituted C₁-C₇ cycloalkanoyl,

(11) optionally substituted C₄-C₇ cycloalkenoyl,

(12) optionally substituted C₁-C₁₀ alkylsulfonyl

(13) optionally substituted C₃-C₈ cycloalkyl

(14) optionally substituted C₅-C₈ cycloalkenyl

where the substituents on the alkyl, alkenyl, alkynyl, alkanoyl, alkenoyl, alkynoyl, benzoyl, phenyl, cycloalkanoyl, cycloalkenoyl, alkylsulfonyl, cycloalkyl and cycloalkenyl are from 1 to 5 groups independently selected from hydroxy, C₁-C₆ alkoxy, C₃-C₇ cycloalkyl, aryl C₁-C₃ alkoxy, NR^{g}R^{h}, CO₂R^{b}, CONR^{c}R^{d} and halogen,

(15) C₁-C₅ perfluoroalkyl,

(16) phenylsulfonyl optionally substituted with 1 to 3 groups independently selected from C₁-C₅ alkyl, C₁-C₅ perfluoroalkyl, nitro, halogen or cyano,

(17) a 5- or 6-member ring selected from piperidino, morpholino, pyridyl and piperazino optionally substituted by 1 to 4 groups independently selected from C₁-C₅ alkyl, C₁-C₅ alkenyl, C₁-C₅ perfluoroalkyl, amino, C(O)R^{c}R^{d}, cyano, CO₂R^{b} or halogen;

R^{b} is

(1) H,

(2) optionally substituted phenyl,

(3) optionally substituted C₁-C₁₀ alkyl,

(4) optionally substituted C₃-C₁₀ alkenyl, or

(5) optionally substituted C₃-C₁₀ alkynyl,

where the substituents on the phenyl, alkyl, alkenyl or alkynyl are from 1 to 5 groups independently selected from hydroxy, C₁-C₆ alkoxy, C₃-C₇ cycloalkyl, halogen, C₁-C₅ alkanoyloxy, C(O)NR^{c}R^{d}, CO₂R^{b}, formyl, —NR^{g}R^{h}, optionally substituted phenyl, and optionally substituted phenyl C₁-C₃ alkoxy, wherein the phenyl substituents are 1 to 3 groups independently selected from R^{e};

R^{c} and R^{d} are independently R^{b}; or

R^{c} and R^{d} together with the N to which they are attached form a piperidino, morpholino or piperazino optionally substituted with 1 to 3 groups independently selected from R^{g} and oxo;

R^{e} is

(1) halogen,

(2) C₁-C₇ alkyl,

(3) C₁-C₃ perfluoroalkyl,

(4) —S(O)ₘRⁱ,

(5) cyano,

(6) nitro,

(7) R^{j}O(CH₂)ᵥ-,

(8) R^{j}CO₂(CH₂)ᵥ-,

(9) R^{j}OCO(CH₂)ᵥ,

(10) optionally substituted phenyl where the substituents are from 1 to 3 halogen, C₁-C₆ alkyl, C₁-C₆ alkoxy, or hydroxy;

v is 0 to 3;

R^{g} and R^{h} are independently

(1) hydrogen,

(2) C₁-C₆ alkyl,

(3) aryl,

(4) aryl C₁-C₆ alkyl,

(5) C₁-C₅ alkoxycarbonyl,

(6) C₁-C₅ alkylcarbonyl, or

(7) C₁-C₅ alkanoyl C₁-C₅ alkyl; or

R^{g} and R^{h} together with the N to which they are attached form a piperidino, morpholino or piperazino optionally substituted with 1 to 3 groups independently selected from R^{g} and oxo;

Rⁱ and R^{j} are independently

(1) hydrogen,

(2) C₁-C₃ perfluoroalkyl,

(3) optionally substituted C₁-C₆ alkyl, where the substituents are aryl or substituted phenyl;

(4) phenyl or substituted phenyl where the substituents are from 1 to 3 groups independently selected from halogen, C₁-C₆ alkyl, C₁-C₆ alkoxy, or hydroxy;

m is 0 to 2; or a pharmaceutically acceptable salt thereof.

Most especially preferred are compounds of the formula

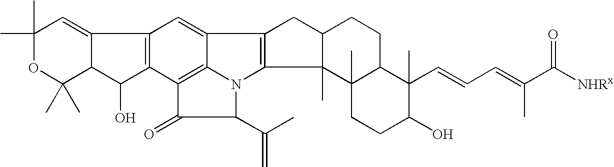

wherein R^{x} is selected from the group consisting of:

H, CH₃, CH₂CH₃, C(CH₃)₃, CH₂CH₂CH₃, CH₂CH₂OH, CH(CO₂CH₃)CH₂OH, CH₂CO₂CH₃, CH₂CH(OCH₂CH₃)₂, CH₂CH₂OCH₂CH₂OH, CH(CH₃)(CH₂)₃C(CH₃)₂OH, (CH₂)₃OH, (CH₂)_{4OH, (CH}₂)SOH, CH(CH2OH)CH₂CH₃, NHC(CH₃)₃, CH₂CN, (CH₂)₆OH, CH₂CH(OH)CH₃, CH(CH₂OH)CH₂CH₂CH₃, CH₂CH₂SCH₃, CH₂CH₂SCH₂CH₃, CH₂CONH, CH(CH₃)(CH₂OH)₂, CH₂CH₂NHCH₂CH₂OH, CH(CH₂OH)(CH₂)₃CH₃, CH(CH2OCH₃)CH₃, (CH₂)₂SH, (CH₂)₄NH₂, CH₂CH₂SO₂CH₃, CH₂CH₂S(O)CH₃, CH(CH(CH₃)₂)CH₂OH, (CH₂)₃NH₂, (CH₂)₃N(CH₂CH₃)₂, (CH₂)₃N(CH₃)₂, OCH₂CH₃, CH₂CH(OH)CH₂OH, OCH₃, CH₂CH₂OCH₃, CH₂CH₂NHC(O)CH₃, C(CH₃)₂CH₂OH, c-C₃H₅, c-C₆H₁₁, (CH₂)₃OCH₂CH₃, CH₂CH≡CH₂, C(CH₂CH₃)(CH₂OH)₂, CH₂C≡CH, CH₂CO₂CH₂CH₃, CH₂CH₂F, (CH₂)₃OCH₂)₁₁ CH₃, CH₂CH₂N(CH₃)₂, CH₂CH₂OCH₂CH₂NH₂, CH₂CF₃, NHCH₂CO₂CH₂CH₃, CH(CH₃)CO₂CH₃, C(CH₃)₂CH₂C(O)CH₃, CH(CO₂CH₂CH₃)₂, CH₂CH₃, CH(CH₂CH₂CH₃)CO₂CH₃, CH₂CH₂CH₂OCH₃, C(CH₃)₂C≡CH, (CH₂)₄CH₃, CH(CH₂CH₂CH₃)₂, (CH₂)₅CH₃,CH₂CH₂CO₂H, CH(CH(CH₃)₂)CO₂CH₃, OCH₂CO₂H, CH(CH(CH₃)₂)CH₂OH, CH(CH(CH₃)₂)CH₂OH, CH(CH₃)CH₂OH, CH(CH₃)CH₂OH, CH(CH₃)₂, C(CH₃)₃, (CH₂)CH(CH₃)₂, CH(CH₃)CH₂CH₃, CH₂CH(CH₃)OH, (CH₂)₃CH₃, (CH₂)₂OCH₂CH₃, 1-adamantyl, (CH₂)₈CH₃, CH(CH₃)CH(CH₃)₂, (CH₂)₃NHCH₃, (CH₂)₂N(CH₂CH₃)₂,

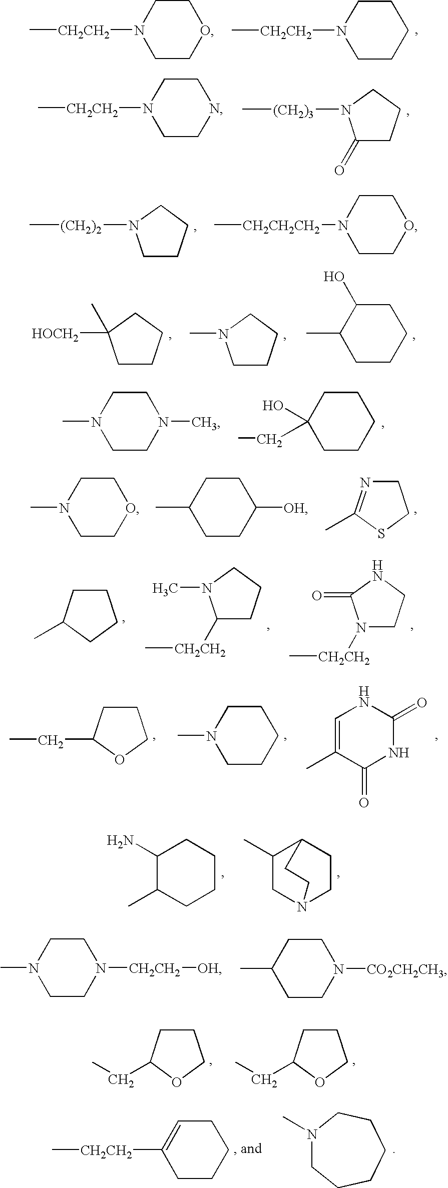

An especially preferred nodulisporamide derivative is one wherein R^{X} is t-butyl.

“Alkyl” as well as other groups having the prefix “alk”, such as alkoxy, alkanoyl, alkenyl, alkynyl and the like, means carbon chains which may be linear or branched or combinations thereof. Examples of alkyl groups include methyl, ethyl, propyl, isopropyl, butyl, sec- and tert-butyl, pentyl, hexyl, heptyl and the like. “Alkenyl”, “alkynyl” and other like terms include carbon chains containing at least one unsaturated C—C bond.

The term “cycloalkyl” means carbocycles containing no heteroatoms, and includes mono-, bi- and tricyclic saturated carbocycles, as well as benzofused carbocycles. Examples of cycloalkyl include cyclopropyl, cyclobutyl, cyclopentyl, cyclohexyl, decahydronaphthalene, adamantane, indanyl, indenyl, fluorenyl, 1,2,3,4-tetrahydronaphalene and the like. Similarly, “cycloalkenyl” means carbocycles containing no heteroatoms and at least one non-aromatic C—C double bond, and include mono-, bi- and tricyclic partially saturated carbocycles, as well as benzofused cycloalkenes. Examples of cycloalkenyl include cyclohexenyl, indenyl, and the like.

The term “halogen” is intended to include the halogen atoms fluorine, chlorine, bromine and iodine.

The term “heterocycle”, unless otherwise specified, means mono- or bicyclic compounds that are saturated or partly unsaturated, as well as benzo- or heteroaromatic ring fused saturated heterocycles or partly unsaturated heterocycles, and containing from 1 to 4 heteroatoms independently selected from oxygen, sulfur and nitrogen. Examples of saturated heterocycles include morpholine, thiomorpholine, piperidine, piperazine, tetrahydropyran, tetrahydrofuran, dioxane, tetrahydrothiophene, oxazolidine, pyrrolidine; examples of partly unsaturated heterocycles include dihydropyran, dihydropyridazine, dihydrofuran, dihydrooxazole, dihydropyrazole, dihydropyridine, dihydropyridazine and the like. Examples of benzo- or heteroaromatic ring fused heterocycle include 2,3-dihydrobenzofuranyl, benzopyranyl, tetrahydroquinoline, tetrahydroisoquinoline, benzomorpholinyl, 1,4-benzodioxanyl, 2,3-dihydrofuro(2,3-b)pyridyl and the like.

The term “aryl” is intended to include mono- and bicyclic aromatic and heteroaromatic rings containing from 0 to 5 heteroatoms independently selected from nitrogen, oxygen and sulfur. The term “aryl” is also meant to include benzofused cycloalkyl, benzofused cycloalkenyl, and benzofused heterocyclic groups. Examples of “aryl” groups include phenyl, pyrrolyl, isoxazolyl, pyrazinyl, pyridinyl, oxazolyl, thiazolyl, imidazolyl, triazolyl, tetrazolyl, furanyl, triazinyl, thienyl, pyrimidinyl, pyridazinyl, pyrazinyl, naphthyl, benzoxazolyl, benzothiazolyl, benzimidazolyl, benzofuranyl, furo(2,3-B)pyridyl, 2,3-dihydrofuro(2,3-b)pyridyl, benzoxazinyl, benzothiophenyl, quinolinyl, indolyl, 2,3-dihydrobenzofuranyl, benzopyranyl, 1,4-benzodioxanyl, indanyl, indenyl, fluorenyl, 1,2,3,4-tetrahydronaphthalene and the like.

Aroyl means arylcarbonyl in which aryl is as defined above.

Examples of NR^{c}R^{d} or NR^{g}R^{h} forming a 3- to 10-membered ring containing 0 to 2 additional heteroatoms selected from O, S(O)ₘ and N are aziridine, azetidine, pyrrolidine, piperidine, thiomorpholine, morpholine, piperazine, octahydroindole, tetrahydroisoquinoline and the like.

The term “optionally substituted” is intended to include both substituted and unsubstituted; thus, for example, optionally substituted aryl could represent a pentafluorophenyl or a phenyl ring.

Certain of the above defined terms may occur more than once in the above formula and upon such occurrence each term shall be defined independently of the other; thus, for example, OR^{a} at C₄ may represent OH

Compounds of formula (I) are available commercially or can be prepared according to one or other of the processes or any other process coming within the competence of a person skilled in the art who is an expert in chemical synthesis. For the chemical preparation of the products of the invention, a person skilled in the art is regarded as having at his disposal, inter alia, the entire contents of “Chemical Abstracts” and of the documents which are cited therein. Semi-synthetic processes are described, for example, in U.S. Pat. No. 6,399,786 or WO 96/29073, both of which are incorporated by reference.

The terms “nodulisporic acid or nodulisporic acid derivative” also include the pharmaceutically or veterinary acceptable acid or base salts, where applicable, of these compounds. The term “acid” contemplates all pharmaceutically or veterinary acceptable inorganic or organic acids. Inorganic acids include mineral acids such as hydrohalic acids, such as hydrobromic and hydrochloric acids, sulfuric acids, phosphoric acids and nitric acids. Organic acids include all pharmaceutically or veterinary acceptable aliphatic, alicyclic and aromatic carboxylic acids, dicarboxylic acids tricarboxylic acids and fatty acids. Preferred acids are straight chain or branched, saturated or unsaturated C₁-C₂₀ aliphatic carboxylic acids, which are optionally substituted by halogen or by hydroxyl groups, or C₆-C₁₂ aromatic carboxylic acids. Examples of such acids are carbonic acid, formic acid, fumaric acid, acetic acid, propionic acid, isopropionic acid, valeric acid, α-hydroxy acids, such as glycolic acid and lactic acid, chloroacetic acid, benzoic acid, methane sulfonic acid, and salicylic acid. Examples of dicarboxylic acids include oxalic acid, malic acid, succinic acid, tataric acid and maleic acid. An example of a tricarboxylic acid is citric acid. Fatty acids include all pharmaceutically or veterinary acceptable saturated or unsaturated aliphatic or aromatic carboxylic acids having 4 to 24 carbon atoms. Examples include butyric acid, isobutyric acid, sec-butyric acid, lauric acid, palmitic acid, stearic acid, oleic acid, linoleic acid, linolenic acid, and phenylsteric acid. Other acids include gluconic acid, glycoheptonic acid and lactobionic acid.

The term “base” contemplates all pharmaceutically or veterinary acceptable inorganic or organic bases. Such bases include, for example, the alkali metal and alkaline earth metal salts, such as the lithium, sodium, potassium, magnesium or calcium salts. Organic bases include the common hydrocarbyl and heterocyclic amine salts, which include, for example, the morpholine and piperidine salts.

The ester and amide derivatives of these compounds, where applicable, are also contemplated. Specific compounds which belong to these classes of therapeutic agents are well known to the practitioner of this art.

The avermectin and milbemycin series of compounds are potent anthelmintic and antiparasitic agents against a wide range of internal and external parasites. The compounds which belong to this series are either natural products or are semi-synthetic derivatives thereof. The structure of these two series of compounds are closely related and they both share a complex 16-membered macrocyclic lactone ring; however, the milbemycin do not contain the aglycone substituent in the 13-position of the lactone ring. The natural product avermectins are disclosed in U.S. Pat. No. 4,310,519 to Albers-Schonberg, et al., and the 22, 23-dihydro avermectin compounds are disclosed in Chabala, et al., U.S. Pat. No. 4,199,569. For a general discussion of avermectins, which include a discussion of their uses in humans and animals, see “Ivermectin and Abamectin,” W. C. Campbell, ed., Springer-Verlag, New York (1989). Naturally occurring milbemycins are described in Aoki et al., U.S. Pat. No. 3,950,360 as well as in the various references cited in “The Merck Index” 12 h ed., S. Budavari, Ed., Merck & Co., Inc. Whitehouse Station, New Jersey (1996). Semisynthetic derivatives of these classes of compounds are well known in the art and are described, for example, in U.S. Pat. Nos. 5,077,308, 4,859,657, 4,963,582, 4,855,317, 4,871,719, 4,874,749, 4,427,663, 4,310,519, 4,199,569, 5,055,596, 4,973,711, 4,978,677, and U.S. Pat. No. 4,920,148.

Avermectins and milbemycins share the same common 16-membered macrocyclic lactone ring; however, milbemycins do not possess the disaccharide substituent on the 13-position of the lactone ring.

While many avermectin compounds are known in the art, a representative

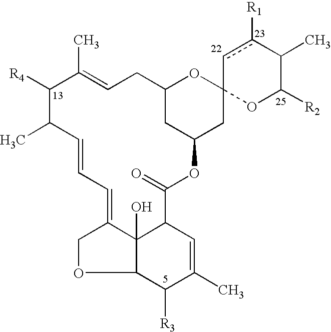

structure of the class of compounds is as follows:

where the broken line indicates a single or a double bond at the 22,23-positions;

R₁ is hydrogen or hydroxy provided that R₁ is present only when the broken line indicates a single bond;

R₂ is alkyl of from 1 to 6 carbon atoms or alkenyl of from 3 to 6 carbon atoms or cycloalkyl of from 3 to 8 carbon atoms;

R₃ is hydroxy, methoxy or ═NOR₅ where R₅ is hydrogen or lower alkyl; and

R₄ is hydrogen, hydroxy or

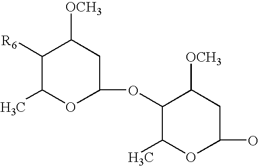

where R₆ is hydroxy, amino, mono-or di-lower alkylamino or lower alkanoylamino.

The preferred compounds are avermectin Bla/Blb (abamectin), 22,23-dihydro avermectin Bla/Blb (ivermectin) and the 4″-acetylamino-5-ketoximino derivative of avermectin Bla/Blb. Both abamectin and ivermectin are approved as broad spectrum antiparasitic agents.

The structures of abamectin and ivermectin are as follows:

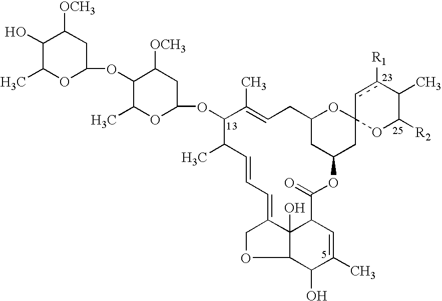

wherein for abamectin the broken line represents a double bond and R₁ is not present and for ivermectin the double bond represents a single bond and R₁ is hydrogen; and

R₂ is isopropyl or sec-butyl.

The 4″-acetyl amino-5-ketoximino derivatives of avernectin Bla/Blb has the following structural formula:

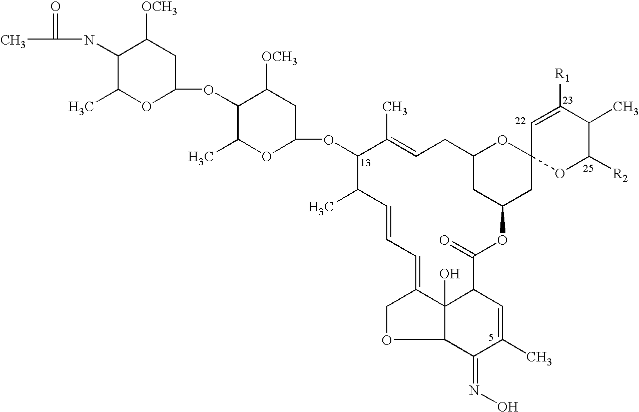

where R₂ is isopropyl or sec-butyl.

The avermectin products are generally prepared as a mixture of at least 80% of the compound where R₂ is sec-butyl and no more than 20% of the compound where R₂ is isopropyl.

Other preferred avermectins, include ememectin, eprinomectin and doramectin. Doramectin is disclosed in U.S. Pat. No. 5,089,490 and EP 214 738. This compound has the following structure:

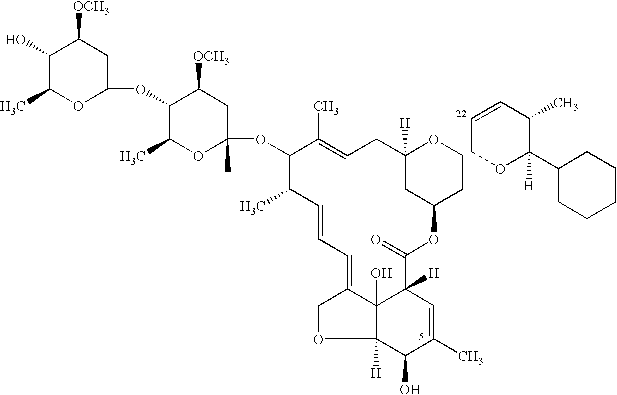

In the present formulations, ivermectin and eprinomectin are especially preferred.

A representative structure for a milbemycin is that for milbemycin α₁:

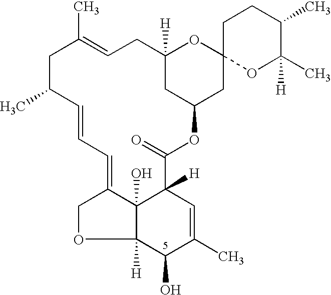

An especially preferred milbemycin is moxidectin, whose structure is as follows:

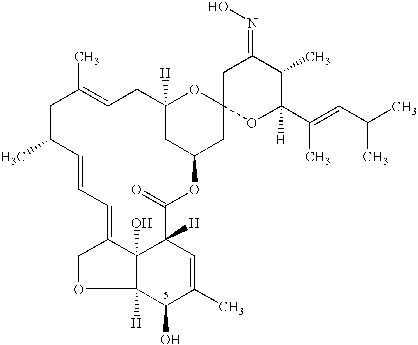

The compound is disclosed in U.S. Pat. No. 5,089,490.

The monosaccharide avermectin derivatives are also preferred especially where an oxime substitution is present on the 5-position of the lactone ring. Such compounds are described, for example, in EP 667,054. Selamectin is an especially preferred compound of this class of derivatives.

Other pharmaceutical or therapeutic agents are those known in the art to treat parasitic infection caused by nematodes and trematodes. In order to treat cestode (and trematode) infections in warm-blooded animals, it is know, to administer 2-acyl4-oxo-pyrazino-isoquinoline derivatives to the animal (see, e.g., U.S. Pat. No. 4,001,441, herein incorporated by reference). A compound of this class that is often used to treat cestode and nematode infections is praziquantel, which has the following structure:

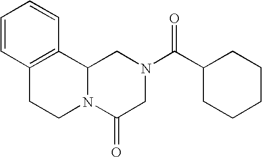

Often it is beneficial to administer a formulation that contains a combination of two or more anthelmintics, which possess different activity, in order to obtain a composition with a broad spectrum of activity. For example, avermectin are ineffective against cestodes, such as tapeworms, and thus are ineffective against an infestation caused by roundworms and tapeworms. Further, the combination allows the user to administer one formulation instead of two or more different formulations to the animal. Formulations which administer a combination of two or more anthelmintics are know in the art. These formulations may be in the form of solutions, suspensions, pastes, drenches or pour-on formulations (see, e.g., U.S. Pat. No. 6,165,987 to Harvey, U.S. Pat. No. 6,340,672 to Mihalik or copending application U.S. Ser. No. 10/177,822 entitled Anthelmintic Oral Homogeneous Veterinary Pastes, filed on Jun. 21, 2002 herein incorporated by reference). For example, U.S. Pat. No. 4,468,390 to Kitano and U.S. Pat. No. 5,824,653 to Beuvry et al. describe anthelmintic compositions for treating nematode and cestode infections in animals, such as horses, that comprise an avermectin or a milbemycin and an isoquinoline compounds, such as praziquantel, to the animal. In these formulations, the avermectin or milbemycin compound and the isoquinoline compound. Similarly, U.S. Pat. No. 6,207,179 to Mihalik describes an anthelmintic paste formulations wherein the avermectin or milbemycin is dissolved in a non-aqueous liquid and pyrantel or morantel, compounds which are in the same class as praziquantel, but are said in the are to be far less effective as praziquantel, are suspended in the liquid. These prior patents do not describe a formulation wherein both the praziquantel and the avermectin or milbemycin that are in a chewable formulation. For example, U.S. Pat. No. 6,165,987 describes anthelmintic formulations containing praziquantel and at least one avermectin or milbemycin dissolved in an ester or ester-like compounds, such as glycerol formal, benzyl alcohol and N-methyl-2-pyrrolidone, which may be liquids, pastes or drenches no mention is made of a chewable formulation or one which is both non-animal products containing and a palatable to the animal.

Other pharmaceutical agents, such as vitamins, mineral supplements, which are know in the veterinary art may also be included in the inventive formulations.

An important feature of the present invention is the flavor that does not contain animal products or is not derived from an animal source. Flavors derived from catnip, the valarian plant or fruit are not contemplated by the present invention. Flavors include those know in pet foods which are artificial and include, for example:

| | |
|---|---|
| DRY GARLIC-ADE OS | Formulated to provide a pungent garlic aroma. |
| LIQUID GARLIC-ADE OS | Same as dry garlic-ade in an oil miscible liquid form. |
| LIQUID GARLIC-ADE | Same as Dry Garlic-Ade but in a concentrated, oil |
| CONCENTRATE OM | miscible liquid form. |
| DRY ONION-ADE | Formulated to deliver an aroma and taste of cooked |
| | onions. |
| DRY GARLIC ONION-ADE | A dry blend of Garlic-Ade and Onion-Ade. |
| DRY CHEESE-ADE | A strong cheddar cheese flavor and aroma. |
| LIQUID CHEESE-ADE OM | An oil miscible, liquid version of Dry Cheese-Ade. |
| DRY CHICKEN-ADE | Formulated to provide the aroma of baked chicken. |
| LIQUID CHICKEN-ADE OS | An oil soluble liquid version of Dry Chicken-Ade. |
| LIQUID CHICKEN-ADE OS | A concentrated form of Liquid Chicken-Ade OS. |
| CONCENTRATE FFA | |
| DRY LIVER-ADE | Formulated to provide the aroma and flavor of cooked |
| | liver. |
| LIQUID LIVER-ADE | A concentrated liquid version of Dry Liver-Ade. |
| CONCENTRATE | |
| DRY PET-ADE BEEF STEW | A blend of many flavor components which provide of beef |
| | stew. |
| LIQUID PET-ADE BEEF STEW OS | An oil soluble, liquid version of Dry Pet-Ade Beef Stew. |
| PET-ADE BEEF STEW | A concentrated liquid version of Dry Pet-Ade Beef Stew. |
| CONCENTRATE | |
| DRY BEEF-ADE | A dry flavor formulated to provide the appeal of a baking |
| | roast. |
| DRY FISH MEAL FLAVOR | A dry flavor formulated to provide the odor of fish meal. |
| CONCENTRATE | |
| LIQUID FISH MEAL FLAVOR | A liquid version of Dry Fish Meal Flavor. |
| CONCENTRATE | |
| DRY KANIN-KRAVE | A spicy bone marrow flavor. |
| DRY BACON-ADE | A dry flavor which provides the aroma of frying bacon. |

Sources for these flavors are well-know to a practitioner in this art. For example, Kermine Petfood Nutrisurance is a vegetarian flavor for pet food is sold by Kemine industries, Inc., Des Moines, Iowa. A discussion of commercial smoke flavorings is provided by Guillen et al. in J. Agr. and Food Chemistry vol. 4.

Preferred are the GRILLIN' line of grill flavors and blends marketed by the Red Arrow Products Company, LLC, Manitowoc, Wis. for human and pet food. These include GRILLIN' TYPE CB-200, GRILLIN' TYPE SD, GRILLIN' TYPE WS-50, GRILLIN' TYPE CN, GRILLIN'TYPE CB, GRILLIN' TYPE GS and GRILLIN' TYPE NBF.

Especially preferred are hickory smoked flavoring produced by combining torula yeast and an aqueous hickory smoke solution, sold by Red Arrow Products Co. as CHARTOR HICKORY or a hickory smoke flavoring produced by combining maltodextin with an aqueous hickory smoke solution, sold by Red Arrow Products Co. as CHARDEX HICKORY. Other flavors contemplated by the invention include those which impart a natural dry smoke flavor. These include CHARZYME (a smoke flavor produced by combining barley malt flour with an aqueous smoke flavor), CHARMAIZE (a smoke flavor produced by combining yellow flower and an aqueous smoke flavor) and CHARSALT (a blend of dendritic salt, aqueous smoke flavor, and dydrated silicon dioxide. All of these flavors may be obtained by Red Arrow Products Co.

The determination of the amounts of flavor for a particular product is easily determined by a practitioner of this art. Typical ranges are from up to about 10%. Also preferred are those flavors which provide a savory flavor. These flavors are well known to a practitioner of this art.

Disintegrants include for example sodium starch glycolate, crospovidone, croscarmellose sodium, starch, micocrystalline cellulose, alginic acid, veegum, crospovidone, bentonite, and pregelatinized starch. Binders may be for example, polyvinyl pyrrolidone, povidone, starch, pregelatinized starch, gelatin, methylcellulose, hydroxypropyl cellulose, carboxymethyl cellulose sodium, ethylcellulose, sodium alginate, tragacanth, and acacia. Non-limiting examples of humectants include propylene glycol, glycerin, polyethylene glycol 400 and polyethylene glycol 3350.

Absorbents may also be added to the inventive formulations. Such compounds are well known in the art to the practitioner as well as their use in pastes. These compounds effectively prevents or alleviates the phase separation of the product during storage. Preferred absorbents include magnesium carbonate, calcium carbonate, potassium bicarbonate, sodium bicarbonate, starch, cellulose and its derivatives, or mixtures of absorbents, with magnesium carbonate being especially preferred. The inclusion of these compounds is optional with amounts of 0% to about 30%, 0 to about 15% or about 1% to about 15% or about 1% to about 10%, based on total weight of the formulation being especially preferred.

Additionally, the inventive formulations may contain other inert ingredients such as antioxidants, preservatives, stabilizers or surfactants. These compounds are well known in the formulation art. Antioxidant such as an alpha tocopheral, ascorbic acid, ascrobyl palmitate, fumeric acid, malic acid, sodium ascorbate, sodium metabisulfate, n-propyl gallate, BHA (butylated hydroxy anisole), BHT (butylated hydroxy toluene) monothioglycerol and the like, may be added to the present formulation. The antioxidants are generally added to the formulation in amounts of from about 0.01 to about 2.0%, based upon total weight of the formulation, with about 0.1 to about 1.0% being especially preferred. Preservatives, such as the parabens (methylparaben and/or propylparaben), are suitably used in the formulation in amounts ranging from about 0.01 to about 2.0%, with about 0.05 to about 1.0% being especially preferred. Other preservatives include benzalkonium chloride, benzethonium chloride, benzoic acid, benzyl alcohol, bronopol, butylparaben, cetrimide, chlorhexidine, chlorobutanol, chlorocresol, cresol, ethylparaben, imidurea, methylparaben, phenol, phenoxyethanol, phenylethyl alcohol, phenylmercuric acetate, phenylmercuric borate, phenylmercuric nitrate, potassium sorbate, sodium benzoate, sodium propionate, sorbic acid, thimerosal, propyl paraben, myristyl gama-picolinium chloride, paraben methyl, paraben propyl and quaternary ammonium compounds and the like.

Granulating solvents are well known to those skilled in this art. Examples of such solvents are water, aqueous sorbitol solution, etc. Other compounds which can act as solvents include polyethylene glycol 3350, glycerol caprylate/caprate and polyglycolized glycerides (GELUCIRE).

Humectants are known in the art and include compounds such as propyleneglycol, glycerine, polyethylene glycol 400 and polyethylene glycol 3350. Humectants may be present in amounts, e.g., in about 0.01% to 20% based upon total weight of formulation.

Surfactants in amounts from about 0.001 to about 1%, based upon total weight may also be added to help solubilize the active drug, to prevent crystallization, and to prevent phase separation. Some examples of the surfactants are: glyceryl monooleate, polyoxyethylene sorbitan fatty acid esters, sorbitan esters, polyvinyl alcohol, Pluronics, polysorbate 80, sodium lauryl sulfate, poloxomers (LUTROL F87), propyleneglycol laurate (LAUROGLYCOL), glycerol caprylate/caprate (CAPMUL MCM) polyglycolized glycerides (GELUCIRE), etc. Again, these compounds, as well as their amounts are well known in the art.

Colorants may be added to the inventive formulations. Colorants contemplated by the present invention are those commonly known in the art. Specific colorants include, for example, dyes, an aluminum lake, caramel (which may also function as a flavor), colorant based upon iron oxide or a mixture of any of the foregoing. Especially preferred are organic dyes and titanium dioxide. Preferred ranges include from about 0.5% to about 25%.

The chewable formulations provided for in the invention may also include lubricants, such as polyethylene glycols (PEG's or CARBOWAX), corn oil, mineral oil, hydrogenated vegetable oils (STEROTEX OR LUBRITAB), peanut oil, magnesium stearate, soybean oil and/or castor oil. The inclusion and identity of a lubricant is readily determined by a practitioner of this art are present in amounts, for example, of about 0.01 to about 20%, based upon total weight in the composition.

Compounds which stabilize the pH of the formulation (pH modifiers) are also contemplated. Again, such compounds are well known to a practitioner in the art as well as how to use these compounds. Buffering systems include, for example, systems selected from the group consisting of acetic acid/acetate, malic acid/malate, citric acid/citrate, tataric acid/tartrate, lactic acid/lactate, phosphoric acid/phosphate, glycine/glycimate, tris, glutamic acid/glutamates and sodium carbonate. Preferred ranges for pH include from about 4 to about 6.5.

Other compounds contemplated by the inventive formulations include complexing agents, such as cyclodextrins, PVP, PEG, ethyl lactate and niacinamide. Amounts of such compounds to be included in the inventive formulation are well known to a practitioner of the art. Also contemplated are therapeutic agents to be in the form of emulsions, liposomes or micelles.

The inventive formulation may be administered to a warm-blooded animals, such as cattle, sheep, pigs, cats, dogs, horses, llamas, deer, rabbits, skunks, raccoons, camels and the like, or birds. The formulations contemplated by the invention can also be used with humans. The amount of pharmaceutical active agent depends on the individual therapeutic agent, the animal being treated, the disease state, and the severity of the disease state. The determination of those factors is well within the skill level of the practitioner. Generally, such preparation normally contain about 0.0005 to about 50% of therapeutic agent by total weight of composition. For nodulisporic acid and nodulisporic acid derivatives, a formulation containing about 0.0005 to about 5% of the active compound is preferred. Preferred formulations are those containing about 0.01 to 10% of therapeutic agent and especially preferred formulations are those containing about 2.5 to about 5% of therapeutic agent. Other preferred amounts include about 0.1 to about 0.01 to about 50% or about 10% or about 0.5 to about 3%. For the avermectins and milbemycins, the formulations will generally be prepared to administer from about 0.1 to about 2 mg/kg, preferably from about 0.4 to about 0.85 mg/kg and most preferably from about 0.6 to about 0.7 mg/kg of the active ingredient. At a preferred dose volume of about 1 ml to treat 50 kg of animal body weight the formulation contains from about 5 to about 50 mg of the active agent per ml of solution or about 0.5 to about 10%, preferably about 2.5 to about 5% w/v. However, depending upon the activity of the compound and the animal being treated, doses as low as about 0.3% of the active ingredient are usable. For nodulisporic acid and its derivatives, a formulation containing about 0.0005 to about 5% of the active compound is preferred.

For chewable veterinary formulation comprising an avermectin or a milbemycin and an antiparasitic agent for nematodes or trematodes, such as praziquantel or pyrantel, preferred amounts of praziquantel include, for example, from about 0.5 mg/kg to about 7.5 mg/kg of animal body weight, with a range of about 0.5 mg/kg to about 2 mg/kg or 2.5 mg/kg of body weight being especially preferred. A most especially preferred amount is about 1.0 mg/kg of animal body weight. Preferred ranges for the anthelmintic macrolide compounds include, for example about 0.01 to about 200 mg/kg of animal body weight, with the ranges of about 0.1 to about 50 mg/kg and from about 1 to about 30 mg/kg being especially preferred.

This invention further provides for tablets that do not contain animal products which comprise, in addition to the non-animal product containing flavor or flavor derived from a non-animal source, at least one nodulisporic acid or nodulisporic acid derivative, flavor, filler, lubricant, and flow aid. Optionally, the inventive tablets may further contain at least one of the following ingredients: colorants, binders, antioxidants, disintegrants, or preservatives. Moreover, in an alternative embodiment this invention provides for tablets which are coated. The inventive tablets are prepared according to methods conventional in the art, such as wet and dry granulation processes.

Many of the ingredients for the tablet include those provided for in the chewable formulations. With respect to fillers (or diluents), the inventive tablets contemplate all the fillers which are known in the tablet art. Non-limiting examples of fillers include anhydrous lactose, hydrated lactose, sprayed dried lactose, crystalline maltose and maltodextrins.

Flow aids or glidants are also well known in the art and include, for example, silicon dioxide (CARBOSIL) or silica gel (SYLOID), talc, starch, calcium, stearate, magnesium stearate, and aluminum magnesium silicate (NEUSILIN). Amounts of flow aids are readily determined by a practitioner in this art and include for using about 0.01 to about 25%, based upon weight of total composition. Non-limiting examples of lubricants for the tablets include magnesium and calcium stearate and stearic acid. Again, the various lubricants are well known to a practitioner of this art as well as the amounts of these compounds. Ranges include from about 0.01 to about 20%.

The chewable formulations and tablets provided for by this invention may be coated using techniques conventional in the art. Coatings for chewables veterinary formulations include gelatin, glyceryl behenate, coca butter, and beeswax. Other coatings would be known to a practitioner in this art. Coatings for tablets include sugar coatings, such as seal coatings, subcoatings, and syrup coatings, as well as film coatings, such as pan-pour coatings and pan spray coatings. As well known to a practitioner of this art, the coatings contain additional components such as solvents, plasticizers, colorants, opaquant-extenders and film formers.

The inventive oral formulations may be used to treat a number of disease states by administering to the host in need thereof an effective amount of the oral formulation containing the pharmaceutical agent. The determining of a treatment protocol of a specific indication would be well within the skill level of a practitioner in the pharmaceutical or veterinary arts. The hosts include all animals, e.g. cats, dogs, cattle, sheep, horses, and pigs. As mentioned above, the oral formulation provided for by this invention also could be used to treat disease states in human hosts.

### EXAMPLES

A better understanding of the present invention and of its many advantages will be had from the following examples, given by way of illustration.

### Example 1

Palatability Studies

This test determined which of the four alternative, non-animal product containing flavors for a pharmaceutical agent such as a COX-2 inhibitor, nodulisporic acid or a nodulisporic acid derivative would be most readily be accepted by dogs in a daily home-use situation. The four alternative, non-animal flavors were selected from a field of sixteen flavors in qualitative testing with employee dogs. The control was a tablet which contained real pork liver.

The formulations, which were in the form of tablets, were prepared as follows:

Control: Formulation containing 6% real pork liver:

| INGREDIENT | MANUFACTURER | % w/w |
|---|---|---|
| Stock Granulation | | 92.9 |
| Natural Liver Flavor | American Laboratories | 6.0 |
| Magnesium Stearate | | 1.1 |
| Lactose | Foremost | 0.0 |
| Total | | 100.0 |

Inventive: Formulation containing 4% CHARDEX

| INGREDIENT | MANUFACTURER | % w/w |
|---|---|---|
| Stock Granulation | | 92.9 |
| CHARDEX | Red Arrow | 4.0 |
| Magnesium Stearate | | 1.1 |
| Lactose | Foremost | 2.0 |
| Total | | 100.0 |

Inventive: Formulation containing 2 % CHARDEX

| INGREDIENT | MANUFACTURER | % w/w |
|---|---|---|
| Stock Granulation | | 92.9 |
| CHARDEX Flavor | Red Arrow | 2.0 |
| Magnesium Stearate | | 1.1 |
| Lactose | Foremost | 4.0 |
| Total | | 100.0 |

Inventive: Formulation containing 4% CHARTOR

| INGREDIENT | MANUFACTURER | % w/w |
|---|---|---|
| Stock Granulation | | 92.9 |
| CHARTOR Flavor | Red Arrow | 4.0 |
| Magnesium Stearate | | 1.1 |
| Lactose | Foremost | 2.0 |
| Total | | 100.0 |

Inventive: Formulation containing 2% CHARDEX and 2% Carnel

| INGREDIENT | MANUFACTURER | % w/w |
|---|---|---|
| Stock Granulation | | 92.9 |
| CHARDEX | Red Arrow | 2.0 |
| Carmel | Foote & Jenks | 4.0 |
| Magnesium Stearate | | 1.4 |
| Total | | 100.0 |

The stock granulation contained the following ingredients:

| INGREDIENT | MANUFACTURER | % w/w |
|---|---|---|
| Open Flavor | FMC | 6.0 |
| (added later) | | |
| Avicel PH 102 | FMC | 15.0 |
| AcDiSol | FMC | 2.8 |
| Magnesium Stearate | | 1.1 |
| (added later) | | |
| Cab O Sil | Cabot | 0.6 |
| Klucel EXF | Hercules | 3.0 |
| Yellow Iron Oxide | Colorcon | 0.13 |
| Red Iron Oxide | Colorcon | 0.27 |
| Fast Flo Lactose | Foremost | 71.1 |
| Total | | 100.00 |

The results of the trials are summarized below:

TABLE I
Palatability Study

| | | | | | | CHARDEX 2% ± |
|---|---|---|---|---|---|---|
| | | Pork Liver | CHARDEX 4% | CHARDEX 2% | CHARTOR 4% | CARMEL4% |
| | | (98) | (85) | (94) | (83) | (79) |
| Mean Days 1-5 | | % | % | % | % | % |
| Accepted tablet (net) | | 94 | 74 | 74 | 85 | 79 |
| Accepted plain tablet 1^{st} attempt | 5 | 80 | 26 | 32 | 60 | 38 |
| Accepted plain tablet >1 attempt | 4 | 10 | 10 | 14 | 13 | 18 |
| Accepted tablet with food/treat 1^{st} attempt | 3 | 3 | 23 | 13 | 9 | 11 |
| Accepted tablet with food/treat >1 attempt | 2 | 1 | 12 | 13 | 2 | 8 |
| Accepted 1^{st} attempt (subnet) | | 83 | 49 | 45 | 68 | 49 |
| Accepted >1 attempt (subnet) | | 11 | 22 | 27 | 15 | 26 |
| Accepted plain (subnet) | | 90 | 36 | 46 | 73 | 57 |
| Accepted with food/treat (subnet) | | 4 | 35 | 26 | 11 | 19 |
| Did not accept this tablet | | 6 | 26 | 26 | 15 | 21 |
| Mean | | 4.6 | 2.9 | 3.1 | 4.0 | 3.4 |

(N = Total Dogs That Tried Flavor

The four synthetic test flavors were accepted by the dogs although not as readily as the formulations flavored with real pork liver.

Specifically, 94% of the dogs accepted the Pork liver tablets overall, with 80% accepting it plain on the first attempt (refusal rate was 6%).

For the artificial flavors, 74% to 85% of the dogs accepted the tables overall, with a range of 25% to 60% of these accepting the tablets plain on the first attempt (i.e., refusal rates were 15% to 26%).

Pork liver scores of “Accepted—94%,” “Accepted plain, 1^{st} attempt—80%,” “Accepted plain—90%,” and “Accepted 1^{st} attempt—83%” are significantly higher than scores for all other tablets at 95%+level of confidence.

CHARTOR was accepted by 85% of the dogs compared to 74-79% for the CHARDEX options. CHARTOR also was more readily accepted, with 60% accepting the tablet plain on the first attempt compared to 26 to 38% for the CHARDEX options.

Overall “Accepted” score significantly higher than CHARDEX 2% and 4% options at 90%+level of confidence.

There were no statistically significant differences between CHARTOR and CHARDEX+Carmel.

There were no statistically meaningful differences in scores between the CHARDEX 2%, 4% and +Caramel options.

While dog owners considered the synthetically flavored formulations more difficult to administer, the “easy” score for formulations flavored with CHARTOR were very acceptable.

TABLE II
Ease of Administration

| | | | | | | CHARDEX 2% + |
|---|---|---|---|---|---|---|
| | | Pork Liver 6% | CHARDEX 4% | CHARDEX 2% | CHARTOR 4% | Carmel 4% |
| | | (98) | (84) | (94) | (82) | (79) |
| Mean Days 1-5 | | % | % | % | % | % |
| Easy (net) | | 91 | 58 | 61 | 82 | 68 |
| Very easy | 4 | 80 | 34 | 40 | 69 | 46 |
| Somewhat easy | 3 | 11 | 24 | 21 | 13 | 22 |
| Somewhat difficult | 2 | 3 | 19 | 18 | 9 | 12 |
| Very difficult | 1 | 6 | 20 | 20 | 9 | 18 |
| Difficult (net) | | 9 | 40 | 37 | 18 | 30 |
| Mean | | 3.7 | 2.7 | 2.8 | 3.4 | 2.9 |

(N = Total Dogs That Tried Flavor)

### Example 2

Study to Determine the Acceptability of Place Non-beef Chewable Formulations in Dogs:

TABLE III
Animal descriptions and sequences

| Animal | | Age | | Formulation # | Formulation # | Formulation # |
|---|---|---|---|---|---|---|
| ID | Sex | (months) | Sequence # | Day 0 | Day 2 | Day 4 |
| 1 | F | 68.2 | 1 | 1 | 2 | 3 |
| 2 | M | 46.1 | 2 | 1 | 3 | 2 |
| 3 | F | 39.5 | 3 | 2 | 1 | 3 |
| 4 | F | 17.9 | 4 | 2 | 3 | 1 |
| 5 | M | 33.9 | 5 | 3 | 1 | 2 |
| 6 | M | 18.9 | 6 | 3 | 2 | 1 |

M = Male,
F = Female

All dogs were Beagles and originally acquired from either Harlan Sprague

All dogs were Beagles and originally acquired from either Harlan Sprague Dawley, Madison, Wis., Merial Limited, Athens, Ga., or Sinclair Research Center, Columbia, Mo.

Formulation 1:

| | |
|---|---|
| Soy Protein Fines | 45% |
| Explotab | 22% |
| CHARDEX Flavor | 3% |
| Povidone K = 90 | 4% |
| Water | 20% |
| Propylene Glycol | 6% |

Formulation 2:

| | |
|---|---|
| Soy Protein Fines | 47% |
| Explotab | 22% |
| CHARDEX Flavor | 1% |
| Povidone K = 90 | 4% |
| Water | 20% |
| Propylene Glycol | 6% |

Formulation 3:

| | |
|---|---|
| Soy Protein Fines | 47% |
| Explotab | 22% |
| Chocolate Flavor | 1% |
| Povidone K = 90 | 4% |
| Water | 20% |
| Propylene Glycol | 6% |

All chewables were offered once on either Day 0, 2, or 4.

TABLE IV
Acceptability Scores

| | FORMULATION 1 | FORMULATION 2 |
|---|---|---|
| 1 | 2* | 1 |
| 2 | 1 | 1 |
| 3 | 1 | 1 |
| 4 | 2* | 1 |
| 5 | 1 | 1 |
| 6 | 1 | 2* |

All chewables were offered one on either Day 0, 2, or 4.
Acceptablity scoring system:
1 = Swallowed readily
2 = Swallowed with coaxing or food
3 = Refused
*An acceptablity score of 2 was recorded as such because the dog played with the chewable before eating it. No chewable had to be given with food.

### Example 2

The following non-animal product containing chewable formulations were prepared according to conventional techniques:

Nodulisporamide Chewable
Batch size 100 g

| # | Ingredients | % |
|---|---|---|
| 1. | Polyethylene Glycol 400 | 20 |
| 2. | Polyethylene Glycol 3350 | 5 |
| 3. | Tenox 2 | 0.02 |
| 4. | Lutrol F87 | 0.5 |
| 5. | Nodulisporamide* | 6.0 |
| 6. | Palapet F5, BFI | 4.0 |
| 7. | Palapet F1, BFI | 2.0 |
| 8. | Micro. Cellulose | 12 |
| 9. | Soy Protein Fines** | 19.98 |
| 10. | Palapet T1, BFI | 2.0 |
| 11. | Palapet T2, BFI | 7.0 |
| 12. | Alginic Acid | 3.0 |
| 13. | Crospovidone | 5.0 |
| 14. | Povidone K-90 | 2.0 |
| 15. | Citric Acid | 1.0 |
| 16. | Potassium Sorbate | 0.5 |
| 17. | Purified Water | 10.0 |
| TOTAL | | 100 |

*Amount of Nodulisporamide on the basis of CoA: 100% (% Assay) 97.5 × 6 g = 6.15 g
**Adjusted amount of Soy Protein Fines according to the amount of Nodulisporamide: (19.98 + 6.0) − 6.15 g = 19.83

Nodulisporamide Chewable
Batch size 100 g

| # | Ingredients | % |
|---|---|---|
| 1. | Gelucire 44/14 | 18 |
| 2. | Laurolglycol 90 | 4 |
| 3. | Tenox 2 | 0.02 |
| 4. | Lutrol F87 | 0.5 |
| 5. | Nodulisporamide* | 6.0 |
| 6. | Palapet F5, BFI | 4.0 |
| 7. | Palapet F1, BFI | 2.0 |
| 8. | Micro. Cellulose | 12 |
| 9. | Soy Protein Fines** | 22.98 |
| 10. | Palapet T1, BFI | 2.0 |
| 11. | Palapet T2, BFI | 7.0 |
| 12. | Alginic Acid | 3.0 |
| 13. | Crospovidone | 5.0 |
| 14. | Povidone K-90 | 2.0 |
| 15. | Citric Acid | 1.0 |
| 16. | Potassium Sorbate | 0.5 |
| 17. | Purified Water | 10.0 |
| TOTAL | | 100 |

*Amount of Nodulisporamide on the basis of CoA: 100% (% Assay) 97.5 × 6 g = 6.15 g
**Adjusted amount of Soy Protein Fines according to the amount of Nodulisporamide: (22.98 + 6.0) − 6.15 g = 22.83 g

Nodulisporamide Chewable
Batch size 100 g

| # | Ingredients | % |
|---|---|---|
| 1. | Polyethylene Glycol 400 | 20 |
| 2. | Polyethylene Glycol 3350 | 5 |
| 3. | Tenox 2 | 0.02 |
| 4. | Lutrol F87 | 0.5 |
| 5. | Nodulisporamide | 6 |
| 6. | Micro. Cellulose | 12 |
| 7. | Soy Protein Fines | 19.98 |
| 8. | Art. Beef Flavor PC | 15 |
| 9. | Alginic Acid | 3 |
| 10. | Crospovidone | 5 |
| 11. | Povidone K-90 | 2 |
| 12. | Citric Acid | 1 |
| 13. | Potassium Sorbate | 0.5 |
| 14. | Purified Water | 10 |
| TOTAL | | 100 |

*Amount of Nodulisporamide on the basis of CoA: 100% (% Assay) 97.5 × 6 g = 6.15 g
**Adjusted amount of Soy Protein Fines according to the amount of Nodulisporamide: (19.98 g − 6.154 g = 19.826 g

Nodulisporamide Chewable.
Batch size 100 g

| # | Ingredients | % |
|---|---|---|
| 1. | Polyethylene Glycol 400 | 18 |
| 2. | Polyethylene Glycol 3350 | 5 |
| 3. | Tenox 2 | 0.02 |
| 4. | Sod. Lauryl Sulfate | 0.5 |
| 5. | Transubol P | 2 |
| 6. | Nodulisporamide* | 6 |
| 7. | Maladexatrin | 6 |
| 8. | Pregelatized Starch | 10 |
| 9. | Corn Starch** | 20.98 |
| 10. | Art. Beef Flavor PC | 15 |
| 11. | Crospovidone | 5 |
| 12. | Citric Acid | 1 |
| 13. | Potassium Sorbate | 0.5 |
| 14. | Purified Water | 8 |
| 15. | Corn Oil | 2 |
| TOTAL | | 100 |

*Amount of Nodulisporamide on the basis of CoA: 100% (% Assay) 97.5 × 6 g = 6.15 g
**Adjusted amount of Corn Starch according to the amount of Nodulisporamide: (20.98 g − 6.154 g = 20.826 g

Nodulisporamide Chewable
Batch size 100 g

| # | Ingredients | % w/w |
|---|---|---|
| 1. | Polyethylene Glycol 400 | 25 |
| 2. | Tenox 2 | 0.02 |
| 3. | Lutrol F87 | 0.5 |
| 4. | Nodulisporamide* | 6.0 |
| 5. | Palapet F5 | 3.0 |
| 6. | Palapet F1 | 1.0 |
| 7. | Soy Protein Fines** | 34.89 |
| 8. | Palapet T1 | 3.0 |
| 9. | Palapet T2 | 5.0 |
| 10. | Aliginic Acid | 3.0 |
| 11. | Crospovidone | 3.0 |
| 12. | Povidone K-90 | 2.0 |
| 13. | Potassium Sorbate | 0.5 |
| 14. | Purified Water | 8.0 |
| 15. | Corn Oil | 4.0 |
| TOTAL | | 100 |

*Amount of Nodulisporamide on the basis of CoA: 100% (% Assay) 97.5 × 6 g = 6.154 g
**Adjusted amount of Soy Protein Fines according to the amount of Nodulisporamide: 34.98 g − (6.154 g − 6.0 g) = 38.826 g

Nodulisporamide Chewable
Batch size 100 g

| # | Ingredients | % w/w |
|---|---|---|
| 1. | Polyethylene Glycol 400 | 22 |
| 2. | Transcutol P | 2.0 |
| 3. | Tenox 2 | 0.02 |
| 4. | Sodium Lauryl Sulfate | 0.5 |
| 5. | Nodulisporamide | 6.0 |
| 6. | Palapet F5 | 3.0 |
| 7. | Palapet F1 | 5.0 |
| 8. | Emdex | 5.0 |
| 9. | Pregelatized Starch | 10.0 |
| 10. | Corn Starch** | 19.98 |
| 11. | Palapet T1 | 2.0 |
| 12. | Palapet T2 | 5.0 |
| 13. | Alginic Acid | 3.0 |
| 14. | Crospovidone | 5.0 |
| 15. | Povidone K-90 | 2.0 |
| 16. | Potassium Sorbate | 0.5 |
| 17. | Purified Water | 8.0 |
| 18. | Corn Oil | 4.0 |
| TOTAL | | 100 |

*Amount of Nodulisporamide on the basis of CoA: 100% (% Assay) 97.5 × 6 g = 6.154 g
**Adjusted amount of Soy Protein Fines according to the amount of Nodulisporamide: 19.98 g − (6.15 g − 6.0 g) = 19.826 g

Nodulisporamide Chewable
Batch size 200 g

| # | Ingredients | % |
|---|---|---|
| 1. | PEG 400 | 20 |
| 2. | PEG 3350 | 5 |
| 3. | Tenox 2 | 0.02 |
| 4. | Lutrol F87 | 0.5 |
| 5. | Nodulisporamide | 8 |
| 6. | Avicel | 12 |
| 7. | Soy Protein Fines | 19.98 |
| 8. | Art. Beef Flavor | 16 |
| 9. | Alginic Acid | 3 |
| 10. | Crospovidone | 5 |
| 11. | Povidone K-90 | 2 |
| 12. | Citric Acid | 1 |
| 13. | K Sorbate | 0.5 |
| 14. | Purified Water | 10 |

*Amount of Nodulisporamide on the basis of CoA: 100%/97.4 × 8 g × 2 = 12.320 g
**Adjusted amount of Soy Protein Fines according to the amount of Nodulisporamide: 39.64 g

### Example 2H

Nodulisporamide Chewable
Batch size 100 g

| # | Ingredients | % w/w |
|---|---|---|
| 1. | Nodulisporamide | 6 |
| 2. | PEG 400 | 20 |
| 3. | PEG 3350 | 5 |
| 4. | Tenox 2 | 0.02 |
| 5. | Lutrol L44 | 1 |
| 6. | Scorbic Acid | 0.5 |
| 7. | Povidone K-90 | 2 |
| 8. | Crospovidone | 5 |
| 9. | Art. Beef Flavor | 15 |
| 10. | Soy Protein Fines | 17.48 |
| 11. | Alginic Acid | 3 |
| 12. | Avicel PH102 | 8 |
| 13. | Purified Water | 10 |
| 14. | Citric Acid | 1 |
| 15. | Sterotex HM | 3 |
| 16. | Corn Oil | 3 |
| TOTAL | | 100 |

*Adjusted Wt. of Nodulisporamide: 100%/97.4% × 6 = 6.160 g
**Adjusted Wt. of Soy Protein Fines: 17.48 g − (6.160 g − 6 g) = 17.32 g

### Example 2I

Nodulisporamide Chewable
Batch size 100 g

| # | Ingredients | % w/w |
|---|---|---|
| 1. | Nodulisporamide | 6 |
| 2. | Lutrol L44 PEG 3350 | 1 |
| 3. | Sorbic Acid | 0.2 |
| 4. | Povidone K-90 | 4 |
| 5. | Crospovidone | 5 |
| 6. | Soy Protein Fines | 33.8 |
| 7. | Avicel PH102 | 12 |
| 8. | Purified Water | 30 |
| 9. | Sterotex HM | 4 |
| 10. | Corn Oil | 4 |
| TOTAL | | 100 |

*Adjusted Wt. of Nodulisporamide: 100%/97.4% × 6 = 6.160 g
**Adjusted Wt. of Soy Protein Fines: 33.8 g − (6.160 g − 6 g) = 33.64 g

### Example 2J

Nodulisporamide Chewable
Batch size 100 g

| # | Ingredients | % w/w |
|---|---|---|
| 1. | Nodulisporamide | 6 |
| 2. | Lutrol L44 | 3 |
| 3. | Sorbic Acid | 0.2 |
| 4. | Povidone K-90 | 4 |
| 5. | Crospovidone | 5 |
| 6. | Soy Protein Fines | 26.8 |
| 7. | Avicel PH102 | 12 |
| 8. | Purified Water | 35 |
| 9. | Sterotex HM | 4 |
| 10. | Corn Oil | 4 |
| TOTAL | | 100 |

*Adjusted Wt. of Nodulisporamide: 100%/97.4% × 6 − 6.160 g
**Adjusted Wt. of Soy Protein Fines: 26.8 g − (6.160 g − 6 g) 26.64 g

### Example 2K

Nodulisporamide Chewable
Batch size 100 g

| # | Ingredients | % w/w |
|---|---|---|
| 1. | Nodulisporamide | 6 |
| 2. | PEG 400 | 20 |
| 3. | PEG 3350 | 5 |
| 4. | Tenox 2 | 0.02 |
| 5. | Lutrol L44 | 1 |
| 6. | Sorbic Acid | 0.5 |
| 7. | Povidone K-90 | 2 |
| 8. | Crospovidone | 5 |
| 9. | Soy Protein Fines | 32.40 |
| 10. | Alginic Acid | 3 |
| 11. | Avicel PH102 | 8 |
| 12. | Purified Water | 10 |
| 13. | Citric Acid | 1 |
| 14. | Sterotex HM | 3 |
| 15. | Corn Oil | 3 |
| TOTAL | | 100 |

*Adjusted Wt. of Nodulisporamide: 100%/97.4% × 6 = 6.160 g
**Adjusted Wt. of Soy Protein Fines: 32.48 g − (6.160 g − 6 g) = 32.32 g

### Example 3

The following four non-animal products containing chewable formulations were prepared according to conventional techniques:

| | 3A | | 3B | | 3C | | 3D | |
|---|---|---|---|---|---|---|---|---|
| | % | Wt | % | Wt | % | Wt | % | Wt |
| Mannitol granular | 65.0 | 30.62 | 65.0 | 30.62 | 65.0 | 30.62 | 65.0 | 30.62 |
| 2080 | | | | | | | | |
| Sodium Lauryl | 0.5 | 0.25 | 0.5 | 0.25 | 0.5 | 0.25 | 0.5 | 0.25 |
| Sulfate | | | | | | | | |
| Crospovidone | 2.0 | 1.00 | 2.0 | 1.00 | 2.0 | 1.00 | 2.0 | 1.00 |
| Chartor Hickory lot 1001-9 | 2.0 | 1.00 | 2.0 | 1.00 | 2.0 | 1.00 | 2.0 | 1.00 |
| Nodulisporamide | 0.0 | 0.00 | 0.0 | 0.00 | 15.0 | 9.38 | 15.0 | 9.38 |
| Milled | | | | | | | | |
| Nodulisporamide | 15.0 | 9.38 | 15.0 | 9.38 | 0.0 | 0.0 | 0.0 | 0.00 |
| Povidone USP K-25 | 3.0 | 1.50 | 3.0 | 1.50 | 3.0 | 1.5 | 3.0 | 1.5 |
| Capmul MCM | 0.0 | 0.00 | 6.0 | 3.00 | 0.0 | 0.0 | 6.0 | 3.00 |
| Ascorbic Acid | 0.0 | 0.00 | 0.0 | 0.00 | 0.0 | 0.0 | 1.0 | .50 |
| Ethyl Alcohol, Absolute | TBD | TBD | TBD | TBD | 0.0 | 0.0 | 0.0 | 0.00 |
| Water USP | 0.0 | 0.00 | 0.0 | 0.0 | TBD | TBD | TBD | TBD |
| Mannitol granular | 10.4 | 5.20 | 4.4 | 2.20 | 10.4 | 5.2 | 3.4 | 1.70 |
| 2080 | | | | | | | | |
| Crospovidone | 2.0 | 1.00 | 2.0 | 1.00 | 2.0 | 1.0 | 2.0 | 1.00 |
| Mg Stearate Flavor | 0.1 | 0.05 | 0.1 | 0.05 | 0.1 | 0.05 | 0.1 | 0.05 |
| Total | 100.0 | 50.00 | 100.0 | 50.00 | 100.0 | 50.00 | 100.0 | 50.00 |

### Example 4

Eprinomectin-Praziquantel Chewable
Formulation 4

| # | Ingredients | Source | % |
|---|---|---|---|
| 1. | Polyethylene Glycol 400 | JTBaker | 20 |
| 2. | Tenox 2 | Eastman | 0.02 |
| 3. | Lutrol F87 | BASF | 0.5 |
| 4. | Eprinomectin* | Merck | 0.0114 |
| 5. | Praziquantel** | Merck | 4.25 |
| 6. | Soy Protein Fines*** | ADM | 37.719 |
| 7. | Art. Beef Flavor PC | PC | 15 |
| 8. | Crospovidone | ISP | 5 |
| 9. | Povidone K-90 | ISP | 2 |
| 10. | Citric Acid | NA | 1 |
| 11. | Potassium Sorbate | Spectrum | 0.5 |
| 12. | Purified Water | Merial | 10 |
| 13. | Corn Oil | Sigma | 4 |
| TOTAL | | | 100 |

*Amount of Eprinomectin on the basis of CoA: 100%/(% Assay) 97.4% × 0.0114 × 2 g = 0.023 g
**Amount of Praziquantel on the basis of CoA: 100%/(% Assay) 99% × 4.25 × 2 g = 8.856 g
***Adjust amount of Soy Protein Fines according to the amount of Eprinomectin & Praziquantel: 75.351 g

This formula was prepared as follows:

1. Mix components 1 and 2.

2. Dissolve with stirring components 3, 4 and 5 in step 1 in sequence. If necessary, use heating to dissolve.

3. Mix items 6 to 9 in a planetary mixer for 10 minutes.

4. Granulate step 3 with solution of step 2.

5. Dissolve Citric Acid in 50% of water and add to step 3.

6. Dissolve Potassium Sorbate in rest of the water and add to step 3.

7. Mix as required.

8. Add Corn Oil & mix.

9. Make extrudate.

10. Dry the extrudates at 50° C. for 2 hour.

### Example 5

A non-animal product containing chewable formulation comprising the following components:

Eprinomectin-Praziquantel Chewable
Formulation 5

| # | Ingredients | Source | % |
|---|---|---|---|
| 1. | Propylene Glycol | JTBaker | 20 |
| 2. | Tenox 2 | Eastman | 0.02 |
| 3. | Sod. Lauryl Sulfate | Fisher | 0.5 |
| 4. | Eprinomectin* | Merck | 0.0114 |
| 5. | Praziquantel** | E Merck | 4.25 |
| 6. | Emdex | Penwest | 10 |
| 7. | Pregelatinized Starch | Colorcon | 10 |
| 8. | Corn Starch*** | NA | 21.719 |
| 9. | Art. Beef Flavor PC | Pharma C | 15 |
| 10. | Crospovidone | ISP | 5 |
| 11. | Citric Acid | Sigma | 1 |
| 12. | Potassium Sorbate | Spectrum | 0.5 |
| 13. | Purified Water | Merial | 8 |
| 14. | Corn Oil | Sigma | 4 |
| TOTAL | | | 100 |

*Amount of Eprinomectin on the basis of CoA: 100%/(% Assay) 97.4% × 0.0114 × 2 g = 0.023 g
**Amount of Praziquantel on the basis of CoA: 100%/(% Assay) 99% × 4.25 × 2 g = 8.586 g
***Adjust amount of Corn Starch according to the amount of Eprinomectin & Praziquantel = 43.351 g.

The above formula was prepared as follows:

1. Mix items 1 and 2.

2. Dissolve with stirring items 3, 4 and 5 in step 1 in sequence. Heat if necessary.

3. Mix items 6 to 10 in a planetary mixer for 10 minutes.

4. Granulate step 3 with solution of step 2.

5. Mix for 10 minutes or as required.

6. Dissolve citric acid in 8 g of Water. Continue granulation of step 5.

7. Dissolve potassium sorbate in 8 g of water. Add to step 5 & continue granulation.

8. Add Corn Oil. Mix for 5 minutes.

9. Make extrudate.

10. Dry the extrudates at 50° C. for 2 hour.

### Example 6

The following ivermectin/pyrantel chewable formulation is prepared according to conventional techniques.

Ivermectin/Pyrantel Pamoate 68 μ/163 mg
Batch Size 500 g/200 Chewables

| # | Ingredient | % w/w |
|---|---|---|
| 1 | Ivermectin | 0.00286* |
| 2 | Tenox 2 | 0.02 |
| 3 | Sorbic Acid | 0.2 |
| 4 | Propylene Glycol | 8.0 |
| 5 | Pyrantel Parnoate | 6.52 |
| 6 | Soy Protein Fines | 30.26 |
| 7 | Art. Beef Flavor | 20.0 |
| 8 | Alginic | 2.0 |
| 9 | Crospovidone | 7.0 |
| 10 | Povidone K-90 | 4.0 |
| 11 | Purified Water | 14.0 |
| 12 | Sterotex HM | 4.0 |
| 13 | Corn Oil | 4.0 |

*Percentage contains 5% overage.
^{a}Weight adjustment of Ivermectin: 100%/90.07% × 0.0143 g × 1000 mg = 16 mg
^{b}Weight adjustment of Pyrantel Pamote: 100%/98.9% × 32.6 g = 32.96 g
^{c}Adjusted amount of Soy Protein Fines: 150.884 g

### Example 7

The following non-animal product containing chewable formulations are prepared according to conventional techniques.

Eprinomectin Non-Beef Chewable Tablets (0.0114% w/w, 4.25% w/w)

| Ingredient | 7A | 7B | 7C | 7D | 7E | 7F | 7G |
|---|---|---|---|---|---|---|---|
| Eprinomectin | 0.0114 | 0.0114 | 0.0114 | 0.0114 | 0.0114 | 0.0114 | 0.0114 |
| Praziquantel | 4.25 | 4.25 | 4.25 | 4.25 | 4.25 | 4.25 | — |
| Sorbic Acid | — | — | — | — | — | 0.2 | 0.2 |
| Propylene | — | — | 8 | 8 | 8 | 8 | 8 |
| Glycol | | | | | | | |
| Glycol | 8 | 10 | — | — | — | — | — |
| Gelatin | — | 2 | — | — | — | — | — |
| Cocoa Butter | — | — | | 7 | — | — | — |
| Compritol | — | — | 10 | — | — | — | — |
| Beeswax | — | — | — | — | 7 | — | — |
| Avicel PH-101 | — | — | 2 | — | — | — | — |
| Soy Protein | 33.72 | 30.72 | 19.72 | 26.72 | 26.72 | 32.52 | 36.77 |
| Fine | | | | | | | |
| Art. Beef Flavor | 20 | 20 | 20 | 20 | 20 | 20 | 20 |
| Tenox | 0.02 | 0.02 | 0.02 | 0.02 | 0.02 | 0.02 | 0.02 |
| Alginic | 2 | 2 | 2 | 2 | 2 | 2 | 2 |
| Crospovidone | 3 | 3 | 5 | 3 | 3 | 7 | 7 |
| Povidone K-90 | 5 | 4 | 5 | 5 | 5 | 4 | 4 |
| Purified Water | 15 | 15 | 15 | 15 | 15 | 14 | 14 |
| Sterotex NF | 4 | 4 | 4 | 4 | 4 | 4 | 4 |
| Corn Oil | 5 | 5 | 5 | 5 | 5 | 4 | 4 |

### Example 8

The following non-animal product containing chewable tablet formulations are prepared according to conventional techniques.

### Example 8A

Non-Beef Chewable Tablets Containing Moxidectin

| Ingredient | Percentage (w/w) |
|---|---|
| Moxidectin | 0.0014 |
| Tenox | 0.02 |
| Propylene Glycol | 8 |
| Citric Acid | 0.5 |
| Soy Protein Fines | 20-45 |
| Art. Beef Flavor | 20 |
| Beeswax | 0-7 |
| Potasium Sorbate | 0.2 |
| Alginic Acid | 2 |
| Crospovidone | 5-7 |
| Povidone K-90 | 4-6 |
| Purified Water | 9-14 |
| Sterotex BF | 4 |
| Corn Oil | 4-8 |

### Example 8B

Non-Beef Chewable Tablet Containing Moxidectin and Pyrantel Pamoate

| Ingredient | Percentage (w/w) |
|---|---|
| Moxidectin | 0.0014 |
| Pyrantel Pamoate | 2.27 |
| Tenox | 0.02 |
| Propylene Glycol | 8 |
| Citric Acid | 0.5 |
| Soy Protein Fines | 20-45 |
| Art. Beef Flavor | 20 |
| Beeswax | 0-7 |
| Potasium Sorbate | 0.2 |
| Alginic Acid | 2 |
| Crospovidone | 5-7 |
| Povidone K-90 | 4-6 |
| Purified Water | 9-14 |
| Sterotex BF | 4 |
| Corn Oil | 4-8 |

### Example 8C

Non-Beef Chewable Tablets Containing Moxidectin and Praziquantel

| Ingredient | Percentage (w/w) |
|---|---|
| Moxidectin | 0.0014 |
| Praziquantel | 3.41 |
| Tenox | 0.02 |
| Propylene Glycol | 8 |
| Citric Acid | 0.5 |
| Soy Protein Fines | 20-45 |
| Art. Beef Flavor | 20 |
| Beeswax | 0-7 |
| Potasium Sorbate | 0.2 |
| Alginic Acid | 2 |
| Crospovidone | 5-7 |
| Povidone K-90 | 4-6 |
| Purified Water | 9-14 |
| Sterotex BF | 4 |
| Corn Oil | 4-8 |

### Example 8D

Non-Beef Chewable Tablets Containing Milbemycin Oxime

| Ingredient | Percentage (w/w) |
|---|---|
| Milbemycin Oxime | 0.227 |
| Tenox | 0.02 |
| Propylene Glycol | 8 |
| Citric Acid | 0.5 |
| Soy Protein Fines | 20-45 |
| Art. Beef Flavor | 20 |
| Beeswax | 0-7 |
| Potasium Sorbate | 0.2 |
| Alginic Acid | 2 |
| Crospovidone | 5-7 |
| Povidone K-90 | 4-6 |
| Purified Water | 9-14 |
| Sterotex BF | 4 |
| Corn Oil | 4-8 |

### Example 8E

Non-Beef Tablets Containing Milbemycin Oxime and Pyrantel Pamoate

| Ingredient | Percentage (w/w) |
|---|---|
| Milbemycin Oxime | 0.227 |
| Pyrantel Pamoate | 2.27 |
| Tenox | 0.02 |
| Propylene Glycol | 8 |
| Citric Acid | 0.5 |
| Soy Protein Fines | 20-45 |
| Art. Beef Flavor | 20 |
| Beeswax | 0-7 |
| Potasium Sorbate | 0.2 |
| Alginic Acid | 2 |
| Crospovidone | 5-7 |
| Povidone K-90 | 4-6 |
| Purified Water | 9-14 |
| Sterotex BF | 4 |
| Corn Oil | 4-8 |

### Example 8F

Non-Beef Chewable Tablets Containing Milbemycin Oxime and Praziquantel

| Ingredient | Percentage (w/w) |
|---|---|
| Milbemycin | 0.227 |
| Praziquantel | 3.41 |
| Tenox | 0.02 |
| Propylene Glycol | 8 |
| Citric Acid | 0.5 |
| Soy Protein Fines | 20-45 |
| Art. Beef Flavor | 20 |
| Beeswax | 0-7 |
| Potasium Sorbate | 0.2 |
| Alginic Acid | 2 |
| Crospovidone | 5-7 |
| Povidone K-90 | 4-6 |
| Purified Water | 9-14 |
| Sterotex BF | 4 |
| Corn Oil | 4-8 |

The above description of the invention is intended to be illustrative and not limiting. Various changes or modifications in the embodiment described may occur to those skilled in the art. These can be made without departing from the scope or spirit of the invention.

What is claimed is:

1. A chewable veterinary formulation, which does not contain animal products, which comprises:
effective amount of a pharmaceutically active agent which comprises either:
a) at least one nodulisporamide acid or nodulisporic acid derivative; or
b) a combination comprising:
i) at least one avermectin or milbemycin derivative; and
ii) at least one compound selected from the group consisting of praziquantel and pyrantel;
at least one filler;
at least one disintegrant;
at least one non-animal product containing flavor or flavor derived from a non-animal source;
at least one binder;
at least one humectant;
at least one granulating solvent;
optionally, at least one antioxidant, at least one pH modifier, at least one surfactant, at least one preservative, at least one lubricant or at least one colorant; and
optionally, a coating

2. The chewable veterinary formulation according to claim 1, wherein the pharmaceutically active agent comprises either:
a) at least one nodulisporic acid derivative of the formula 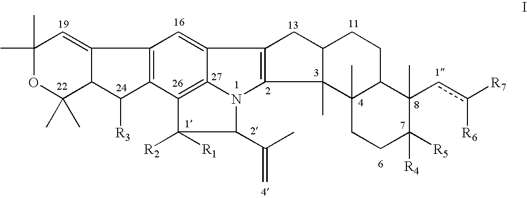
wherein
R₁ is
(1) hydrogen,
(2) optionally substituted alkyl,
(3) optionally substituted alkenyl,
(4) optionally substituted alkynyl,
(5) optionally substituted cycloalkyl,
(6) optionally substituted cycloalkenyl, where the substituents on the alkyl, alkenyl, alkynyl, cycloalkyl and cycloalkenyl are 1 to 3 groups independently selected from
(i) alkyl,
(ii) X-alkyl, where X is O or S(O)ₘ,
(iii) cycloalkyl,
(iv) hydroxy,
(v) halogen,
(vi) cyano,
(vii) carboxy,
(viii) NY¹Y², where Y¹ and Y² are independently H or alkyl,
(ix) alkanoylamino, and
(x) aroylamino wherein said aroyl is optionally substituted with 1 to 3 groups independently selected from R^{f}
(7) aryl or arylalkyl wherein said aryl is optionally substituted with 1 to 3 groups independently selected from R^{f},
(8) perfluoroalkyl
(9) a 5- or 6-member heterocycle containing from 1 to 4 heteroatoms independently selected from oxygen, sulfur and nitrogen atoms optionally substituted by 1 to 3 groups independently selected from hydroxy, oxo, alkyl and halogen, and which may be saturated or partly unsaturated,
R₂, R₃, and R₄ are independently OR^{a}, OCO₂R^{b}, OC(O)NR^{c}R^{d}; or
R₁ and R₂ together represent ═O, ═NOR^{a} or ═N—NR^{c}R^{d};
R₅ and R₆ are H; or
R₅ and R₆ together represent —O—;
R₇ is
(1) CHO, or
(2) the fragment 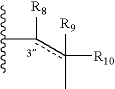
R₈ is
(1) H,
(2) OR^{a}, or
(3) NR^{c}R
R₉is
(1) H,or
(2) OR^{a};
R₁₀ is
(1) CN,
(2) C(O)OR^{b},
(3) C(O)N(OR^{b})R^{c},
(4) C(O)NR^{c}R^{d},
(5) NHC(O)OR^{b},
(6) NHC(O)NR^{c}R^{d},
(7) CH₂OR^{a},
(8) CH₂OCO₂R^{b},
(9) CH₂OC(O)NR^{c}R^{d},
(10) C(O)NRCNR^{c}R^{d}, or
(11) C(O)NR^{c}SO₂R^{b}; 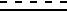
represents a single or a double bond;
R^{a} is
(1) hydrogen,
(2) optionally substituted alkyl,
(3) optionally substituted alkenyl,
(4) optionally substituted alkynyl,
(5) optionally substituted alkanoyl,
(6) optionally substituted alkenoyl,
(7) optionally substituted alkynoyl,
(8) optionally substituted aroyl,
(9) optionally substituted aryl,
(10) optionally substituted cycloalkanoyl,
(11) optionally substituted cycloalkenoyl,
(12) optionally substituted alkylsulfonyl
(13) optionally substituted cycloalkyl
(14) optionally substituted cycloalkenyl where the substituents on the alkyl, alkenyl, alkynyl, alkanoyl, alkenoyl, alkynoyl, aroyl, aryl, cycloalkanoyl, cycloalkenoyl, alkylsulfonyl, cycloalkyl and cycloalkenyl are from 1 to 10 groups independently selected from the group consisting of hydroxy, alkoxy, cycloalkyl, aryl alkoxy, NR^{g}R^{h}, CO₂R^{b}, CONR^{c}R^{d} and halogen,
(15) perfluoroalkyl,
(16) arylsulfonyl optionally substituted with 1 to 3 groups independently selected from alkyl, perfluoroalkyl, nitro, halogen and cyano,
(17) a 5- or 6-member heterocycle containing 1 to 4 heteroatoms selected from oxygen, sulfur and nitrogen optionally substituted by 1 to 4 groups independently selected from alkyl, alkenyl, perfluoroalkyl, amino, C(O)NR^{c}R^{d}, cyano, CO₂R^{b} and halogen, and which may be saturated or partly unsaturated;
R^{b} is
(1) H,
(2) optionally substituted aryl,
(3) optionally substituted alkyl,
(4) optionally substituted alkenyl,
(5) optionally substituted alkynyl,
(6) optionally substituted cycloalkyl,
(7) optionally substituted cycloalkenyl, or
(8) optionally substituted heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups independently selected from
(i) hydroxy,
(ii) alkyl,
(iii) oxo,
(iv) SO₂NR^{g}R^{h},
(v) arylalkoxy,
(vi) hydroxyalkyl,
(vii) alkoxy,
(viii) hydroxyalkoxy,
(ix) aminoalkoxy,
(x) cyano,
(xi) mercapto,
(xii) alkyl-S(O)ₘ,
(xiii) cycloalkyl optionally substituted with 1 to 4 groups independently selected from R^{e},
(xiv) cycloalkenyl,
(xv) halogen,
(xvi) alkanoyloxy,
(xvii) C(O)NR^{g}R^{h},
(xviii) CO₂Rⁱ,
(xix) formyl,
(xx) —NR^{g}R^{h},
(xxi) 5 to 9-member heterocycle, which may be saturated or partially unsaturated, containing from 1 to 4 heteroatoms independently selected from oxygen, sulfur and nitrogen, and optionally substituted with 1 to 5 groups independently selected from R^{e},
(xxii) optionally substituted aryl, wherein the aryl substituents are 1,2-methylenedioxy or 1 to 5 groups independently selected from R^{e},
(xxiii) optionally substituted arylalkoxy, wherein the aryl substituents are 1,2-methylenedioxy or 1 to 5 groups independently selected from R^{e}, and
(xxiv) perfluoroalkyl;
R^{c} and R^{d} are independently selected from R^{b}; or
R^{c} and R^{d} together with the N to which they are attached form a 3- to 10-member ring containing 0 to 2 additional heteroatoms selected from O, S(O)ₘ, and N, optionally substituted with 1 to 3 groups independently selected from R^{g}, hydroxy, thioxo and oxo;
R^{e} is
(1) halogen,
(2) alkyl,
(3) perfluoroalkyl,
(4) —S(O)ₘRⁱ,
(5) cyano,
(6) nitro,
(7) RⁱO(CH₂)ᵥ-,
(8) RⁱCO₂(CH₂)ᵥ-,
(9) RⁱOCO(CH₂)ᵥ-,
(10) optionally substituted aryl where the substituents are from 1 to 3 of halogen, alkyl, alkoxy, or hydroxy,
(11) SO₂NR^{g}R^{h}, or
(12) amino;
R^{f} is
(1) alkyl,
(2) X-alkyl, where X is O or S(O)ₘ,
(3) alkenyl,
(4) alkynyl,
(5) perfluoroalkyl,
(6) NY¹Y², where Y¹ and Y² are independently H or alkyl,
(7) hydroxy,
(8) halogen, and
(9) alkanoyl amino,
R^{g} and R^{h} are independently
(1) hydrogen,
(2) alkyl optionally substituted with hydroxy, amino, or CO₂Rⁱ
(3) aryl optionally substituted with halogen, 1,2-methylenedioxy, alkoxy., alkyl or perfluoroalkyl,
(4) arylalkyl, wherein the aryl is optionally substituted with perfluorolkyl or 1,2-methylenedioxy;
(5) alkoxycarbonyl,
(6) alkanoyl,
(7) alkanoylalkyl,
(9) arylalkoxycarbonyl,
(10) aminocarbonyl, (11) monoalkylaminocarbonyl
(12) dialkylaminocarbonyl; or
R^{g} and R^{h} together with the N to which they are attached form a 3- to 7-member ring containing 0 to 2 additional heteroatoms selected from O, S(O)ₘ, and N, optionally substituted with 1 to 3 groups independently selected from R^{e} and oxo;
Rⁱ is
(1) hydrogen,
(2) perfluoroalkyl,
(3) alkyl,
(4) optionally substituted aryl, or arylalkyl, where the aryl substituents are from 1 to 3 groups independently selected from halogen, alkyl, alkoxy, and hydroxy;
m is 0 to 2; and
v is 0 to 3; or
a pharmaceutically acceptable salt thereof; or
b) a combination comprising
i) at least one avermectin or milbemycin derivative wherein said avermectin or milbemycin derivative is selected from the group consisting of ivermectin, abamectin, doramectin, emamectin, eprinomectin, moxidectin, selemectin, and milbemycin oxime; and
ii) at least one compound selected from the group consisting of praziquantel and pyrantel;
the filler is selected from the group consisting of soy protein, corn cob, and corn glutton meal;
the disintegrant is selected from the group consisting of sodium starch glycolate, crospovidone, croscarmellose sodium, starch, micocrystalline cellulose, mannitol, alginic acid, veegum, microcrystalline dextrose, crospovidone, bentonite, and pregelatinized starch;
the binder is selected from the group consisting of polyvinyl pyrrolidone, povidone, starch, pregelatinized starch, gelatin, methylcellulose, hydroxypropyl cellulose, carboxymethyl cellulose sodium, ethylcellulose, sodium alginate, tragacanth, and acacia;
the humectant is selected from the group consisting of propylene glycol, glycerin, polyethylene glycol 400 and polyethylene glycol 3350; and
the granulating solvent is water, an aqueous sorbitol solution, glycerol or propylene glycol

3. The chewable veterinary formulation according to claim 2, which further comprises an antioxidant and the antioxidant is an alpha tocopheral, ascorbic acid, ascrobyl palmitate, sodium ascorbate, sodium metabisulfate, n-propyl gallate, butylated hydroxy anisole, butylated hydoxy toluene, monothioglycerol or a mixture of any of the foregoing.

4. The chewable veterinary formulation according to claim 3, which further comprises a colorant and the colorant is a dye, an aluminum lake, caramel, colorant based upon iron oxide or a mixture of any of the foregoing.

5. The chewable veterinary formulation according to claim 4, which further comprises a preservative and the preservative is a compound selected from the group consisting of benzalkonium chloride, benzethonium chloride, benzoic acid, benzyl alcohol, bronopol, butylparaben, centrimide, chlorhexidine, chlorobutanol, chlorocresol, cresol, ethylparaben, imidurea, methylparaben, propylparaben, phenol, phenoxyethanol, phenylethyl, alcohol, phenylmercuric acetate, phenylmecuric borate, phenylmercuric nitrate, potassium sorbate, sodium benzoate, sodium propionate, sorbic acid, thimerosal, propyl paraben, myristyl gamma- picolinium chloride, paraben methyl, paraben propyl, quaternary ammonium compounds and a mixture of any of the foregoing.

6. The chewable veterinary formulation according to claim 2, which further comprises a surfactant selected from the group consisting of glyceryl monooleate, polyoxyethylene, glycerol caprylate/caprate sorbitan esters, polyvinyl alcohol, sodium lauryl sulfate, polyglycolized glycerides, propylene glycol laurate and poloxomers.

7. The chewable veterinary formulation according to claim 2, which further comprises a lubricant and the lubricant is selected from the group consisting of corn oil, polyethylene glycol, mineral oil, magnesium stearate, hydrogenated vegetable oil, peanut oil, soybean oil or castor oil.

8. The chewable veterinary formulation, according to claim 1, which is coated and the coating is gelatin, glycerol behenate, cocoa butter or beeswax.

9. The chewable veterinary formulation accoriding to claim 1 wherein the pharmaceutically active agent comprises either:
a) an effective amount of at least one of nodulisporic acid derivative of the formula 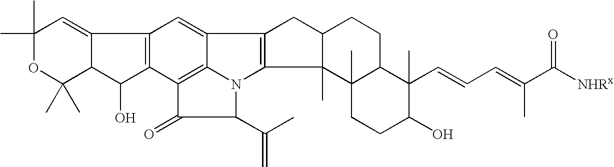
wherein R^{x} is selected from the group consisting of:
H, CH₃, CH₂CH₃, C(CH₃)₃, CH₂CH₂CH₃, CH₂CH₂OH, CH(CO₂CH₃)CH₂OH, CH₂CO₂CH₃, CH₂CH(OCH₂CH₃)₂, CH₂CH₂OCH₂CH₂OH, CH(CH₃)(CH₂)₃C(CH₃)₂OH, (CH₂)₃OH, (CH₂)₄OH, (CH₂)SOH, CH(CH₂OH)CH₂CH₃, NHC(CH₃)₃, CH₂CN, (CH₂)₆OH, CH₂CH(OH)CH₃, CH(CH₂OH)CH₂CH₂CH₃, CH₂CH₂SCH₃, CH₂CH₂SCH₂CH₃, CH₂CONH₂, CH(CH₃)(CH₂OH)₂, CH₂CH₂NHCH₂CH₂OH, CH(CH₂OH)(CH₂)₃CH₃, CH(CH₂OCH₃)CH₃, (CH₂)₂SH, (CH₂)₄NH₂, CH₂CH₂SO₂CH₃, CH₂CH₂S(O)CH₃, CH(CH(CH₃)₂)CH₂OH, (CH₂)₃NH₂, (CH₂)₃N(CH₂CH₃)₂, (CH₂)₃N(CH₃)₂, OCH₂CH₃, CH₂CH(OH)CH₂OH, OCH₃, CH₂CH₂OCH₃, CH₂CH₂NHC(O)CH₃, C(CH₃)₂CH₂OH, c-C₃H₅, cC₆H₁₁, (CH₂)₃OCH₂CH₃, CH₂CH═CH₂, C(CH₂CH₃)(CH₂OH)₂, CH₂C≡CH, CH₂CO₂CH₂CH₃, CH₂CH₂F, (CH₂)₃O(CH₂)₁₁CH₃, CH₂CH₂N(CH₃)₂, CH₂CH₂OCH₂CH₂NH₂, CH₂CF₃, NHCH₂CO₂CH₂CH₃, CH(CH₃)CO₂CH₃, C(CH₃)₂CH₂C(O)CH₃, CH(CO₂CH₂CH₃)₂, CH₂CH₃, CH(CH₂CH₂CH₃)CO₂CH₃, CH₂CH₂CH₂OCH₃, C(CH₃)₂CH₂C≡CH, (CH₂)₄CH₃, CH(CH₂CH₂CH₃)₂, (CH₂)SCH₃,CH₂CH₂CO₂H, CH(CH(CH₃)₂)CO₂CH₃, OCH₂CO₂H, CH(CH(CH₃)₂)CH₂OH, CH(CH(CH₃)₂)CH₂OH, CH(CH₃)CH₂OH, CH(CH₃)CH₂OH, CH(CH₃)₂, (CH₂)CH(CH₃)₂, CH(CH₃)CH₂CH₃, CH₂CH(CH₃)OH, (CH₂)₃CH₃, (CH₂)₂OCH₂CH₃, 1-adamantyl, (CH₂)₈CH₃, CH(CH₃)CH(CH₃)₂, (CH₂)₃NHCH₃, (CH₂)₂N(CH₂CH₃)₂, 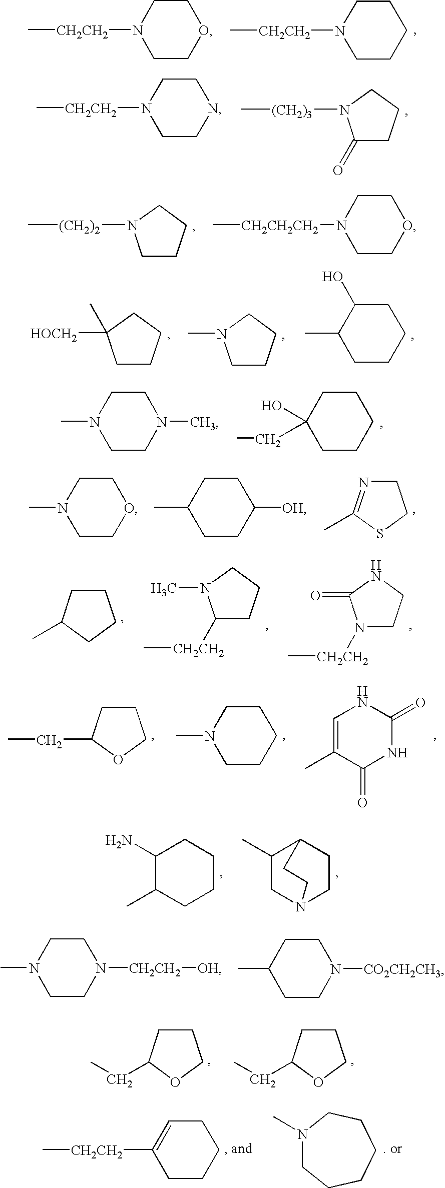
b) a combination comprising
i) at least one avermectin or milbemycin derivative wherein said avermectin or milbemycin derivative is selected from the group consisting of ivermectin, abamectin, doramectin, ememectin, eprinomectin, moxidectin, selemectin, and milbemycin oxime; and
ii) at least one compound selected from the group consisting of praziquantel and pyrantel;
about 20 to about 60% of a filler selected from the group consisting of soy protein, corn cob, or corn glutton meal;
about 1 to about 20% of a disintegrant;
about 0.1 to about 20% of a non-animal product containing flavor or a flavor derived from a non-animal source;
about 0.5 to 10% a binder;
about 5 to about 20% of a humectant; and
about 5 to about 20% granulating solvent, based upon total weight of formulation.

10. The chewable veterinary formulation according to claim 9, which further comprises 0.05% to about 1.0% of an antioxidant, about 0.05 to about 1.0% of a preservative, about 0.01 to 20% of a lubricant and about 0.01 to about 10% of a colorant.

11. A chewable veterinary formulation, which does not contain animal products, which comprises:
an effective amount of a pharmaceutically active agent which comprises either:
a) t-butyl nodulisporamide; or
b) a combination comprising
i) at least one compound selected from the groups consisting or ivermectin, eprinomectin, moxidectin or milbemycin oxime; and
ii) at least one compound selected from the group consisting of pyrantel or praziquantel.
a filler selected from the group consisting of soy protein, corn cob, or corn glutton meal;
disintegrant;
a non-animal product containing flavor or a flavor derived from non-animal sources which is a hickory smoke flavor or a beef flavor;
a binder;
humectant;
granulating solvent; and
optionally, an antioxidant, a pH modifier, preservative, a surfactant, a lubricant or a colorant.

12. The chewable veterinary formulation, according to claim 11, which comprises:
about 20 to about 60% of a filler selected from the group consisting of soy protein, corn cob, or corn glutton meal;
about 1 to about 20% of a disintegrant;
about 0.1 to about 20% of a the hickory smoke flavor;
about 0.5 to about 10% a binder;
about 5 to about 20% of a humectant; and
about 5 to about 20% granulating solvent; and, optionally
about 0.05% to about 1.0% of an antioxidant;
about 0.05 to about 1.0% of a preservative; and
a pH modifier;
about 0.001% to about 1% of a surfactant;
about 0.01% to about 20% of a lubricant
about 0.01 to about 10% of a colorant, based upon total weight of formulation.

13. The chewable veterinary formulation according to claim 1, in which the pharmaceutically effective agent is nodulisporic acid or nodulisporic acid derivative and a second pharmaceutical agent which is other than nodulisporic acid or nodulisporic acid derivative.

14. The chewable veterinary formulation according to claim 12, wherein the disintegrant is selected from the group consisting of sodium starch glycolate, crospovidone, croscarmellose sodium, starches, microcrystalline cellulose, alginic acid, veegum, crospovidone, bentonite, and pregelatinized starch.

15. The chewable veterinary formulation according to claim 12, wherein the binder is selected from the group consisting of polyvinyl pyrrolidone, povidone, starch, pregelatinized starch, gelatin, methylcellulose, hydroxypropyl cellulose, carboxymethyl cellulose sodium, ethylcellulose, sodium alginate, tragacanth, and acacia; and the granulating solvent is water, an aqueous sorbitol solution, glycerol or polypropylene glycerol.

16. The chewable veterinary formulation according to claim 15, which comprises an antioxidant and the antioxidant is selected from the group consisting of alpha tocopherol, ascorbic acid, ascrobyl palmitate, sodium ascorbate, sodium metobisulfate, n-propyl gallate, butylated hydroxy anisole, butylated hydroxy toluene of a mixture of any of the foregoing and monothioglycerol.

17. The chewable veterinary formulation according to claim 15, which comprises a preservative and the preservative and the preservative is selected from the group consisting of the parabens, benzalkonium chloride, benzethonium chloride, benzoic acid, benzyl alcohol, bronopol, cetrimide, chlorhexidine, chlorobutanol, chlorocresol, cresol, imidurea, phenol, phenoxyethanol, phenylethyl alcohol, phenylmercuric acetate, phenylmercuric borate, phenylmercuric nitrate, potassium sorbate, sodium benzoate, sodium propionate, sorbic acid, and thimerosal, propyl paraben, myristyl gamma-picolinium chloride, paraben methyl, paraben propyl, quaternary ammonium compounds, and a mixture of any of the foregoing.

18. The chewable veterinary formulation according to claim 17, comprises a pH modifier and a lubricant and the pH modifier is selected from the group consisting of citric acid, fumeric acid and malic acid and the lubricant which is selected from the group consisting of polyethylene glycols, corn oil, mineral oil, hydrogenated vegetable oils, peanut oil and castor oil.

19. The chewable veterinary formulation according to claim 8 wherein the pharmaceutically active combination is a combination comprising eprinomectin and either praziquantel or pyrantel.

20. A tablet, which does not contain animal products, which comprises
an effective amount of a pharmaceutically active agent which comprises either:
a) at least one nodulisporic acid or nodulisporic acid derivative;
b) a combination comprising
i) at least one avermectin or milbemycin derivative; and
ii) at least one compound selected from the group consisting of praziquantel and pyrantel.
at least one filler;
at least one non-animal product containing flavor or flavor derived from a non-animal source;
at least one lubricant;
at least one flow aid; and
optionally, at least one antioxidant, at least one pH modifier, at least one binder, at least one disintegrant, at least one surfactant, at least one preservative, and at least one colorant, and is optionally coated with at least one coating.

21. The tablet according to claim 20, wherein
the filer is selected from the group consisting of anhydrous lactose, hydrated lactose, spray-dried lactose, crystalline maltose, and a maltodextin;
the flow aid is selected from the group consisting of silicone dioxide, silica gel, talc, starch, calcium stearate, magnesium stearate, and aluminum magnesium stearate; and
the lubricant is selected from the group consisting of magnesium stearate, calcium stearate, stearic acid and waxes.

22. The tablet according to claim 21, wherein
the disintegrant is selected from the group consisting of sodium starch glycolate, crospovidone, croscarmellose sodium, starch, micocrystalline cellulose, alginic acid, veegum, crospovidone, bentonite, and pregelatinized starch; and
the binder is selected from the group consisting of polyvinyl pyrrolidone, povidone, starch, pregelatinized starch, gelatin, methylcellulose, hydroxypropyl
the disintegrant is selected from the group consisting of sodium starch glycolate, crospovidone, croscarmellose sodium, starch, micocrystalline cellulose, alginic acid, veegum, crospovidone, bentonite, and pregelatinized starch; and
the binder is selected from the group consisting of polyvinyl pyrrolidone, povidone, starch, pregelatinized starch, gelatin, methylcellulose, hydroxypropyl cellulose, carboxymethyl cellulose sodium, ethylcellulose, sodium alginate, tragacanth, and acacia.

23. The tablet according to claim 22, which further comprises a colorant and the colorant is a dye, an aluminum lake, caramel, colorant based upon iron oxide or a mixture of any of the foregoing.
